(19) United States
(12) Patent Application Publication
(10) Pub. No.: US 2026/0056396 A1
(43) Pub. Date: Feb. 26, 2026

(54) ZOOM OPTICAL SYSTEM, OPTICAL DEVICE, AND METHOD FOR MANUFACTURING ZOOM OPTICAL SYSTEM

(71) Applicant: NIKON CORPORATION, Shinagawa-ku, Tokyo (JP)

(72) Inventor: Takeru UEHARA, Ageo-shi (JP)

(21) Appl. No.: 19/102,628

(22) PCT Filed: Jul. 24, 2023
(86) PCT No.: PCT/JP2023/026980

§ 371 Date: Feb. 10, 2025

(30) Foreign Application Priority Data
Sep. 9, 2022 (JP) 2022-143715

(51) Int. Cl. G02B 15/14; G02B 13/02; G02B 27/64

(52) U.S. Cl. CPC G02B 15/144511; G02B 13/02; G02B 27/646

(57) ABSTRACT

A zoom optical system (ZL) comprises, in order from an object side along an optical axis, a first lens group (G1) having a negative refractive power, a second lens group (G2) having a positive refractive power, a third lens group (G3) having a negative refractive power, and a fourth lens group (G4) having a positive refractive power, and upon zooming, the first lens group (G1) is fixed relative to an image surface, and a distance between adjacent lens groups is varied, and the following conditional expressions are satisfied:

$$\begin{matrix}0.7 < ( - f 1 ) / f 2 < 1.3 \\ 0.55 < f 2 / ( - f 3 ) < 1.2\end{matrix}$$

where f1: a focal length of the first lens group,
f2: a focal length of the second lens group, and
f3: a focal length of the third lens group.

### TECHNICAL FIELD

The present invention relates to a zoom optical system, an optical device, and a method for manufacturing the zoom optical system.

### TECHNICAL BACKGROUND

Zoom optical systems suitable for photographic cameras, electronic still cameras, video cameras, and the like have been proposed (for example, see Patent Literature 1). However, in such zoom optical systems, it is difficult to achieve excellent optical performance while achieving size reduction.

### PRIOR ARTS LIST

### Patent Document

Patent Literature 1: Japanese Laid-Open Patent Publication No. 2019-040029 (A)

### SUMMARY OF THE INVENTION

A zoom optical system according to the present invention is a zoom optical system comprising, in order from an object side along an optical axis, a first lens group having a negative refractive power, a second lens group having a positive refractive power, a third lens group having a negative refractive power, and a fourth lens group having a positive refractive power, in which upon zooming, the first lens group is fixed relative to an image surface, and a distance between adjacent lens groups is varied, and the following conditional expressions are satisfied:

$$\begin{matrix}0.7 < ( - f 1 ) / f 2 < 1.3 \\ 0.55 < f 2 / ( - f 3 ) < 1.2\end{matrix}$$

where f1: a focal length of the first lens group,
f2: a focal length of the second lens group, and
f3: a focal length of the third lens group.

An optical device according to the present invention comprises the above-described zoom optical system.

A method for manufacturing a zoom optical system according to the present invention is a method for manufacturing a zoom optical system including, in order from an object side along an optical axis, a first lens group having a negative refractive power, a second lens group having a positive refractive power, a third lens group having a negative refractive power, and a fourth lens group having a positive refractive power, and the method comprises arranging lenses in a lens barrel to cause, upon zooming, the first lens group to be fixed relative to an image surface and a distance between adjacent lens groups to be varied, and to satisfy the following conditional expressions:

$$0.7 < ( - f 1 ) / f 2 < 1.3$$

$$0.55 < f 2 / ( - f 3 ) < 1.20$$

where f1: a focal length of the first lens group,
f2: a focal length of the second lens group, and
f3: a focal length of the third lens group.

### BRIEF DESCRIPTION OF THE DRAWINGS

FIG. 1 is a lens configuration diagram of a zoom optical system according to a first example in a wide angle end state;

FIG. 2 is a graph illustrating various aberrations of the zoom optical system according to the first example upon focusing on infinity in the wide angle end state;

FIG. 3 is a graph illustrating various aberrations of the zoom optical system according to the first example upon focusing on infinity in a telephoto end state;

FIG. 4 is a lens configuration diagram of a zoom optical system according to a second example in the wide angle end state;

FIG. 5 is a graph illustrating various aberrations of the zoom optical system according to the second example upon focusing on infinity in the wide angle end state;

FIG. 6 is a graph illustrating various aberrations of the zoom optical system according to the second example upon focusing on infinity in the telephoto end state;

FIG. 7 is a lens configuration diagram of a zoom optical system according to a third example in the wide angle end state;

FIG. 8 is a graph illustrating various aberrations of the zoom optical system according to the third example upon focusing on infinity in the wide angle end state;

FIG. 9 is a graph illustrating various aberrations of the zoom optical system according to the third example upon focusing on infinity in the telephoto end state;

FIG. 10 is a lens configuration diagram of a zoom optical system according to a fourth example in the wide angle end state;

FIG. 11 is a graph illustrating various aberrations of the zoom optical system according to the fourth example upon focusing on infinity in the wide angle end state;

FIG. 12 is a graph illustrating various aberrations of the zoom optical system according to the fourth example upon focusing on infinity in the telephoto end state;

FIG. 13 is a lens configuration diagram of a zoom optical system according to a fifth example in the wide angle end state;

FIG. 14 is a graph illustrating various aberrations of the zoom optical system according to the fifth example upon focusing on infinity in the wide angle end state;

FIG. 15 is a graph illustrating various aberrations of the zoom optical system according to the fifth example upon focusing on infinity in the telephoto end state;

FIG. 16 is a lens configuration diagram of a zoom optical system according to a sixth example in the wide angle end state;

FIG. 17 is a graph illustrating various aberrations of the zoom optical system according to the sixth example upon focusing on infinity in the wide angle end state;

FIG. 18 is a graph illustrating various aberrations of the zoom optical system according to the sixth example upon focusing on infinity in the telephoto end state;

FIG. 19 is a diagram illustrating a configuration of a camera including the zoom optical system according to an embodiment; and

FIG. 20 is a flowchart illustrating a method for manufacturing the zoom optical system according to the present invention.

### DESCRIPTION OF THE EMBODIMENTS

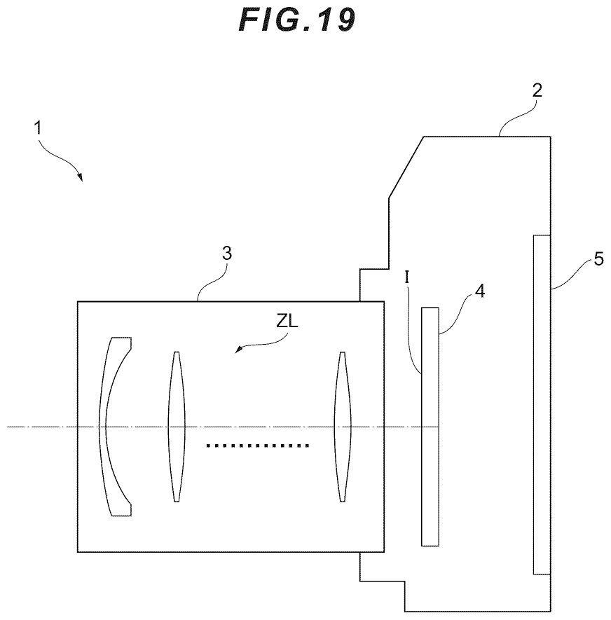

Hereinafter, a preferred embodiment according to the present invention is described. First, a camera (optical device) comprising a zoom optical system according to an embodiment is described with reference to FIG. 19. As illustrated in FIG. 19, a camera 1 includes a main body 2 and an imaging lens 3 mounted on the main body 2. The main body 2 includes an imaging element 4, a main body control part (not illustrated) controlling operation of a digital camera, and a liquid crystal screen 5. The imaging lens 3 includes a zoom optical system ZL comprising a plurality of lens groups, and a lens position control mechanism (not illustrated) controlling positions of the respective lens groups. The lens position control mechanism includes a sensor detecting the positions of the respective lens groups, a motor moving the lens groups back and forth along an optical axis, a control circuit driving the motor, and the like.

Light from an object is condensed by the zoom optical system ZL of the imaging lens 3, and reaches an image surface I of the imaging element 4. The light from the object having reached the image surface I is photoelectrically converted by the imaging element 4, and is recorded as digital image data in an unillustrated memory. The digital image data recorded in the memory can be displayed on the liquid crystal screen 5 in response to operation by a user. The camera may be a mirrorless camera or a single-lens reflex camera including a quick return mirror. The zoom optical system ZL illustrated in FIG. 19 is a schematic illustration of the zoom optical system included in the imaging lens 3, and the lens configuration of the zoom optical system ZL is not limited to the configuration.

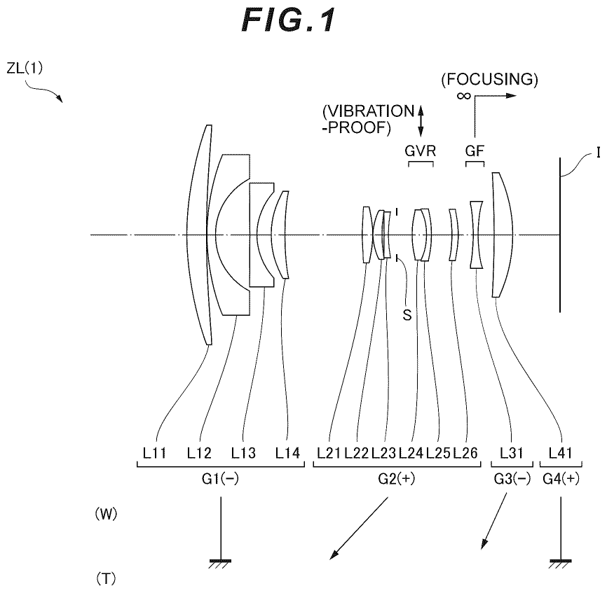

Next, the zoom optical system according to the present embodiment is described. As illustrated in FIG. 1, a zoom optical system ZL(1) as an example of the zoom optical system (zoom lens) ZL according to the present embodiment comprises, in order from an object side along the optical axis, a first lens group having a negative refractive power, a second lens group having a positive refractive power, a third lens group having a negative refractive power, and a fourth lens group having a positive refractive power, and upon zooming, the first lens group is fixed relative to the image surface, and a distance between adjacent lens groups is varied.

The zoom optical system ZL according to the present embodiment satisfies the following conditional expressions (1) and (2) under the above-described configuration:

$$0.7 < ( - f 1 ) / f 2 < 1.3 \qquad ( 1 )$$

$$0.55 < f 2 / ( - f 3 ) < 1.20 \qquad ( 2 )$$

where f1: a focal length of the first lens group,
f2: a focal length of the second lens group, and
f3: a focal length of the third lens group.

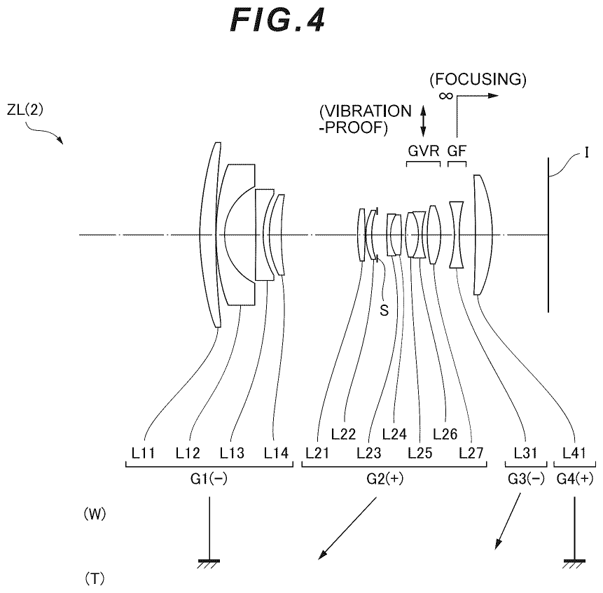

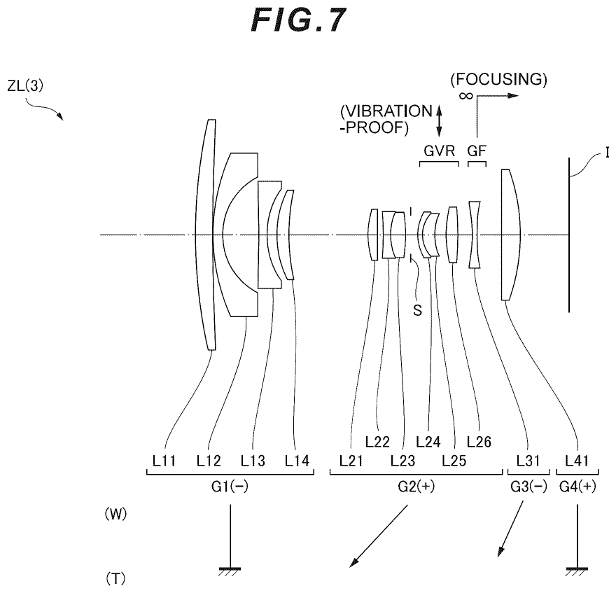

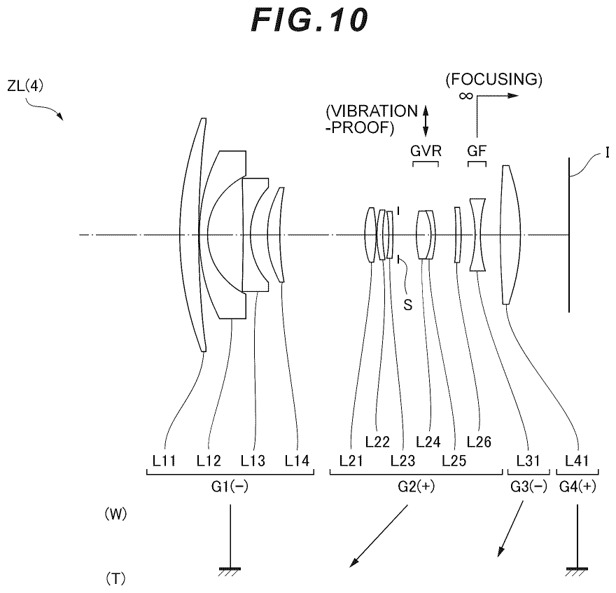

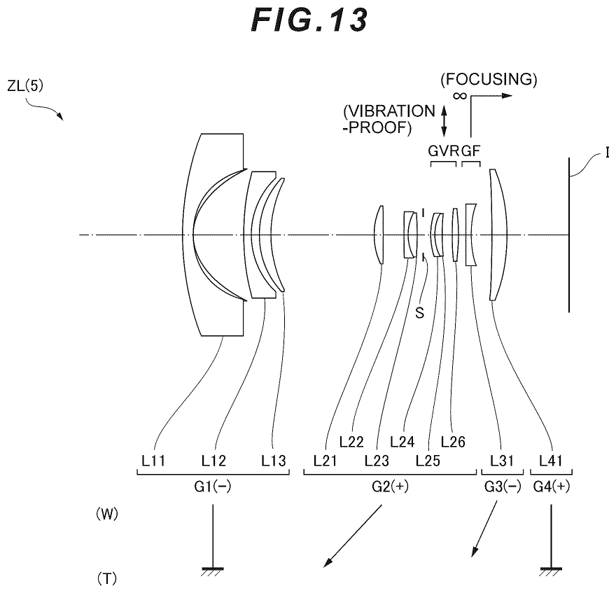

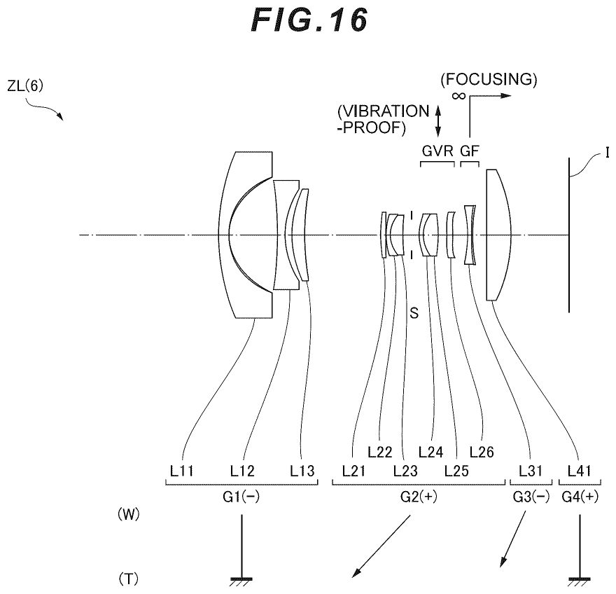

According to the present embodiment, it is possible to provide the zoom optical system including a small size and excellent optical performance, and the optical device including the zoom optical system. For example, when an optical device including a moving image imaging function includes the zoom optical system according to the present embodiment, it is possible to achieve size reduction and excellent optical performance. The zoom optical system ZL according to the present embodiment may be a zoom optical system ZL(2) illustrated in FIG. 4, a zoom optical system ZL(3) illustrated in FIG. 7, a zoom optical system ZL(4) illustrated in FIG. 10, a zoom optical system ZL(5) illustrated in FIG. 13, or a zoom optical system ZL(6) illustrated in FIG. 16.

The conditional expression (1) is a conditional expression for defining a ratio of the focal length f1 of the first lens group and the focal length f2 of the second lens group, and for defining a suitable range. When the zoom optical system ZL satisfies the conditional expression (1), spherical aberration, coma aberration, and curvature of field can be excellently corrected.

When a corresponding value of the conditional expression (1) is lower than a lower limit value, the power of the first lens group is increased, and it is difficult to correct the spherical aberration, the coma aberration, and the curvature of field, which is not preferable. By setting the lower limit value of the conditional expression (1) to 0.75 or 0.80, effects by the present embodiment can be more secured.

On the other hand, when the corresponding value of the conditional expression (1) exceeds an upper limit value, the power of the second lens group is increased, and it is difficult to correct the spherical aberration, the coma aberration, and the curvature of field, which is not preferable. By setting the upper limit value of the conditional expression (1) to 1.25 or 1.20, effects by the present embodiment can be more secured.

The conditional expression (2) is a conditional expression for defining a ratio of the focal length f2 of the second lens group and the focal length f3 of the third lens group, and for defining a suitable range. When the zoom optical system ZL satisfies the conditional expression (2), the spherical aberration, the coma aberration, and the curvature of field can be excellently corrected.

When a corresponding value of the conditional expression (2) is lower than a lower limit value in the zoom optical system, the power of the second lens group is increased, and it is difficult to correct the spherical aberration, the coma aberration, and the curvature of field, which is not preferable. By setting the lower limit value of the conditional expression (2) to 0.60 or 0.65, effects by the present embodiment can be more secured.

On the other hand, when the corresponding value of the conditional expression (2) exceeds an upper limit value, the power of the third lens group is increased, and it is difficult to correct the spherical aberration, the coma aberration, and the curvature of field, which is not preferable. By setting the upper limit value of the conditional expression (2) to 1.10 or 1.00, effects by the present embodiment can be more secured.

The zoom optical system ZL according to the present embodiment preferably satisfies the following conditional expression (3).

$$0.2 < ( - f 1 ) / f 4 < 0.5 \qquad ( 3 )$$

where f4: a focal length of the fourth lens group.

The conditional expression (3) is a conditional expression for defining a ratio of the focal length f1 of the first lens group and the focal length f4 of the fourth lens group, and for defining a suitable range. When the zoom optical system ZL satisfies the conditional expression (3), the spherical aberration, the coma aberration, and the curvature of field can be excellently corrected.

When a corresponding value of the conditional expression (3) is lower than a lower limit value, the power of the first lens group is increased, and it is difficult to correct the spherical aberration, the coma aberration, and the curvature of field, which is not preferable. By setting the lower limit value of the conditional expression (3) to 0.25 or 0.30, effects by the present embodiment can be more secured.

On the other hand, when the corresponding value of the conditional expression (3) exceeds an upper limit value, the power of the fourth lens group is increased, and it is difficult to correct the spherical aberration, the coma aberration, and the curvature of field, which is not preferable. By setting the upper limit value of the conditional expression (3) to 0.45 or 0.42, effects by the present embodiment can be more secured.

The zoom optical system ZL according to the present embodiment preferably satisfies the following conditional expression (4).

$$0.2 < ( - f 3 ) / f 4 < 0 \text{.90} \qquad ( 4 )$$

where f4: the focal length of the fourth lens group.

The conditional expression (4) is a conditional expression for defining a ratio of the focal length f3 of the third lens group and the focal length f4 of the fourth lens group, and for defining a suitable range. When the zoom optical system ZL satisfies the conditional expression (4), the spherical aberration, the coma aberration, and the curvature of field can be excellently corrected.

When a corresponding value of the conditional expression (4) is lower than a lower limit value, the power of the third lens group is increased, and it is difficult to correct the spherical aberration, the coma aberration, and the curvature of field, which is not preferable. By setting the lower limit value of the conditional expression (4) to 0.25 or 0.30, effects by the present embodiment can be more secured.

On the other hand, when the corresponding value of the conditional expression (4) exceeds an upper limit value, the power of the fourth lens group is increased, and it is difficult to correct the spherical aberration, the coma aberration, and the curvature of field, which is not preferable. By setting the upper limit value of the conditional expression (4) to 0.80 or 0.70, effects by the present embodiment can be more secured.

The zoom optical system ZL according to the present embodiment preferably satisfies the following conditional expression (5).

$$0.5 < f 1 / f 3 < 1 \text{.10} \qquad ( 5 )$$

The conditional expression (5) is a conditional expression for defining a ratio of the focal length f1 of the first lens group and the focal length f3 of the third lens group, and for defining a suitable range. When the zoom optical system ZL satisfies the conditional expression (5), the spherical aberration, the coma aberration, and the curvature of field can be excellently corrected.

When a corresponding value of the conditional expression (5) is lower than a lower limit value, the power of the first lens group is increased, and it is difficult to correct the spherical aberration, the coma aberration, and the curvature of field, which is not preferable. By setting the lower limit value of the conditional expression (5) to 0.55 or 0.60, effects by the present embodiment can be more secured.

On the other hand, when the corresponding value of the conditional expression (5) exceeds an upper limit value, the power of the third lens group is increased, and it is difficult to correct the spherical aberration, the coma aberration, and the curvature of field, which is not preferable. By setting the upper limit value of the conditional expression (5) to 1.00 or 0.90, effects by the present embodiment can be more secured.

The zoom optical system ZL according to the present embodiment preferably satisfies the following conditional expression (6).

$$0.2 < f 2 / f 4 < 0 \text{.70} \qquad ( 6 )$$

where f4: the focal length of the fourth lens group.

The conditional expression (6) is a conditional expression for defining a ratio of the focal length f2 of the second lens group and the focal length f4 of the fourth lens group, and for defining a suitable range. When the zoom optical system ZL satisfies the conditional expression (6), the spherical aberration, the coma aberration, and the curvature of field can be excellently corrected.

When a corresponding value of the conditional expression (6) is lower than a lower limit value, the power of the second lens group is increased, and it is difficult to correct the spherical aberration, the coma aberration, and the curvature of field, which is not preferable. By setting the lower limit value of the conditional expression (6) to 0.25 or 0.30, effects by the present embodiment can be more secured.

On the other hand, when the corresponding value of the conditional expression (6) exceeds an upper limit value, the power of the fourth lens group is increased, and it is difficult to correct the spherical aberration, the coma aberration, and the curvature of field, which is not preferable. By setting the upper limit value of the conditional expression (6) to 0.60 or 0.50, effects by the present embodiment can be more secured.

The zoom optical system ZL according to the present embodiment preferably satisfies the following conditional expression (7).

$$0.12 < fw / TLw < 0.1 \; 90 \qquad ( 7 )$$

where fw: a focal length of the zoom optical system in a wide angle end state, and
TLw: an entire length of the zoom optical system in the wide angle end state.

The conditional expression (7) is a conditional expression for defining, in the zoom optical system ZL, a ratio of the focal length fw of the zoom optical system in the wide angle end state and the entire length TLw of the zoom optical system ZL in the wide angle end state, and for defining a suitable range. When the zoom optical system ZL satisfies the conditional expression (7), it is possible to realize the zoom optical system having high optical performance while achieving size reduction.

When a corresponding value of the conditional expression (7) is lower than a lower limit value, it is difficult to realize the zoom optical system having excellent optical performance while achieving size reduction. By setting the lower limit value of the conditional expression (7) to 0.125 or 0.130, effects by the present embodiment can be more secured.

When the corresponding value of the conditional expression (7) exceeds an upper limit value, it is difficult to realize the zoom optical system having excellent optical performance while achieving size reduction. By setting the upper limit value of the conditional expression (7) to 0.185 or 0.180, effects by the present embodiment can be more secured.

The zoom optical system ZL according to the present embodiment preferably satisfies the following conditional expression (8).

$$0.2 < ft / TLt < 0 \text{.50} \qquad ( 8 )$$

where ft: the focal length of the zoom optical system in a telephoto end state, and
TLt: the entire length of the zoom optical system in the telephoto end state.

The conditional expression (8) is a conditional expression for defining, in the zoom optical system ZL, a ratio of the focal length ft of the zoom optical system in the telephoto end state and the entire length TLt of the zoom optical system ZL in the telephoto end state, and for defining a suitable range. When the zoom optical system ZL satisfies the conditional expression (8), it is possible to realize the zoom optical system having high optical performance while achieving size reduction.

When a corresponding value of the conditional expression (8) is lower than a lower limit value, it is difficult to realize the zoom optical system having excellent optical performance while achieving size reduction. By setting the lower limit value of the conditional expression (8) to 0.25 or 0.30, effects by the present embodiment can be more secured.

When the corresponding value of the conditional expression (8) exceeds an upper limit value, it is difficult to realize the zoom optical system having excellent optical performance while achieving size reduction. By setting the upper limit value of the conditional expression (8) to 0.45 or 0.40, effects by the present embodiment can be more secured.

The zoom optical system ZL according to the present embodiment preferably satisfies the following conditional expression (9).

$$0.7 < Mv 2 / f 2 < 1 \text{.30} \qquad ( 9 )$$

where Mv2: a moving amount of the second lens group upon zooming from the wide angle end state to the telephoto end state.

The conditional expression (9) is a conditional expression for defining a ratio of the moving amount Mv of the second lens group upon zooming from the wide angle end state to the telephoto end state and the focal length f2 of the second lens group, and for defining a suitable range. When the zoom optical system ZL satisfies the conditional expression (9), it is possible to realize the zoom optical system having excellent optical performance while achieving size reduction.

When a corresponding value of the conditional expression (9) is lower than a lower limit value, it is difficult to realize the zoom optical system having excellent optical performance while achieving size reduction. By setting the lower limit value of the conditional expression (9) to 0.75 or 0.80, effects by the present embodiment can be more secured.

On the other hand, when the corresponding value of the conditional expression (9) exceeds an upper limit value, it is difficult to correct the spherical aberration, the coma aberration, and the curvature of field, which is not preferable. By setting the upper limit value of the conditional expression (9) to 1.25 or 1.20, effects by the present embodiment can be more secured.

The zoom optical system ZL according to the present embodiment preferably satisfies the following conditional expression (10).

$$0.36 < Mv 3 / ( - f 3 ) < 0 \text{.80} \qquad ( 10 )$$

where Mv3: a moving amount of the third lens group upon zooming from the wide angle end state to the telephoto end state.

The conditional expression (10) is a conditional expression for defining a ratio of the moving amount Mv3 of the third lens group upon zooming from the wide angle end state to the telephoto end state and the focal length f3 of the third lens group, and for defining a suitable range. Upon zooming from the wide angle end state to the telephoto end state, the third lens group is moved toward the object. At this time, the zoom optical system ZL satisfies the conditional expression (10), and it is possible to realize the zoom optical system including excellent optical performance while achieving size reduction.

When a corresponding value of the conditional expression (10) is lower than a lower limit value, it is difficult to achieve excellent optical performance while achieving size reduction. To secure effects by the conditional expression (10), the lower limit is more preferably set to 0.37 or 0.38.

On the other hand, when the corresponding value of the conditional expression (10) exceeds an upper limit value, the power of the third lens group is increased, and it is difficult to correct the spherical aberration, the coma aberration, and the curvature of field, which is not preferable. In addition, the moving amount Mv3 of the third lens group upon zooming is increased, and size reduction of the optical system becomes difficult. To secure effects by the conditional expression (10), the upper limit value is more preferably set to 0.70 or 0.60.

The above-described zoom optical system preferably comprises an aperture stop disposed in the second lens group, and the second lens group preferably includes a vibration-proof lens group disposed on the image surface side of the aperture stop. When the vibration-proof lens group is provided behind the aperture stop in the optical system, it is possible to block light entering at a strong angle, and to achieve excellent vibration-proof performance.

The zoom optical system ZL according to the present embodiment preferably satisfies the following conditional expression (11).

$$1.2 < fvr / f 2 < 2 \text{.20} \qquad ( 11 )$$

where fvr: a focal length of the vibration-proof lens group.

The conditional expression (11) is a conditional expression for defining a ratio of the focal length fvr of the vibration-proof lens group and the focal length f2 of the second lens group, and for defining a suitable range. When the zoom optical system ZL satisfies the conditional expression (11), the spherical aberration, the coma aberration, and the curvature of field can be excellently corrected.

When a corresponding value of the conditional expression (11) is lower than a lower limit value, the power of the vibration-proof lens group is increased, and it is difficult to correct the spherical aberration, the coma aberration, and the curvature of field, which is not preferable. By setting the lower limit value of the conditional expression (11) to 1.30 or 1.40, effects by the present embodiment can be more secured.

On the other hand, when the corresponding value of the conditional expression (11) exceeds an upper limit value, the power of the second lens group is increased, and it is difficult to correct the spherical aberration, the coma aberration, and the curvature of field, which is not preferable. By setting the upper limit value of the conditional expression (11) to 2.10 or 2.00, effects by the present embodiment can be more secured.

The zoom optical system ZL according to the present embodiment preferably satisfies the following conditional expression (12).

$$1. < Mv 2 / Mv 3 < 1 \text{.80} \qquad ( 12 )$$

where Mv2: the moving amount of the second lens group upon zooming from the wide angle end state to the telephoto end state, and
Mv3: the moving amount of the third lens group upon zooming from the wide angle end state to the telephoto end state.

The conditional expression (12) is a conditional expression for defining a ratio of the moving amount Mv2 of the second lens group and the moving amount Mv3 of the third lens group upon zooming, and for defining a suitable range. When the zoom optical system ZL satisfies the conditional expression (12), it is possible to realize the zoom optical system having excellent optical performance while achieving size reduction.

When a corresponding value of the conditional expression (12) is lower than a lower limit value, the moving amount Mv2 of the second lens group upon zooming is reduced, and it is difficult to correct the spherical aberration, the coma aberration, and the curvature of field, which is not preferable. In addition, the moving amount Mv3 of the third lens group is increased, and it is difficult to achieve size reduction. To secure effects by the conditional expression (12), the lower limit value is more preferably set to 1.10 or 1.20.

On the other hand, when the corresponding value of the conditional expression (12) exceeds an upper limit value, the moving amount Mv3 of the third lens group upon zooming is reduced, and it is difficult to correct the spherical aberration, the coma aberration, and the curvature of field, which is not preferable. In addition, the moving amount Mv2 of the second lens group is increased, and it is difficult to achieve size reduction. To secure effects by the conditional expression (12), the upper limit value is more preferably set to 1.75 or 1.70.

In the above-described zoom optical system, focusing from an infinity object to a short-distance object is preferably performed by moving the third lens group on the optical axis. Focusing is performed by using the third lens group, which makes it possible to reduce variation of an angle of view upon focusing.

Upon zooming from the wide angle end state to the telephoto end state, in the above-described zoom optical system, the second lens group and the third lens group are preferably moved toward the object, a distance between the first lens group and the second lens group is preferably reduced, and a distance between the third lens group and the fourth lens group is preferably increased. This makes it possible to realize the zoom optical system having small gravity-center movement upon zooming from the wide angle end state to the telephoto end state and having excellent optical performance.

In the above-described zoom optical system, the fourth lens group is preferably fixed relative to the image surface upon zooming. When the first lens group is fixed relative to the image surface and the fourth lens group is fixed relative to the image surface upon zooming, it is possible to perform zooming without varying the entire length of the zoom optical system, and to realize the zoom optical system having small gravity-center movement and having excellent optical performance.

The zoom optical system ZL according to the present embodiment preferably satisfies the following conditional expression (13).

$$0.15 < Mv 2 / TL < 0 \text{.25} \qquad ( 13 )$$

where Mv2: the moving amount of the second lens group upon zooming from the wide angle end state to the telephoto end state, and
TL: the entire length of the zoom optical system.

The conditional expression (13) is a conditional expression for defining a ratio of the moving amount Mv2 of the second lens group upon zooming and the entire length TL of the zoom optical system, and for defining a suitable range. The entire length TL of the zoom optical system may be an entire length (TLw) of the zoom optical system in the wide angle end state, or an entire length (TLt) of the zoom optical system in the telephoto end state. When the zoom optical system ZL satisfies the conditional expression (13), it is possible to realize the zoom optical system having excellent optical performance while achieving size reduction. To secure effects by the embodiment, a lower limit value of the conditional expression (13) is preferably set to 0.16 or 0.17. In addition, an upper limit value of the conditional expression (13) is preferably set to, for example, 0.20 or 0.19.

The zoom optical system ZL according to the present embodiment preferably satisfies the following conditional expression (14).

$$0.08 < Mv 3 / TL < 0 \text{.20} \qquad ( 14 )$$

where Mv3: the moving amount of the third lens group upon zooming from the wide angle end state to the telephoto end state, and
TL: the entire length of the zoom optical system.

The conditional expression (14) is a conditional expression for defining a ratio of the moving amount Mv3 of the third lens group upon zooming and the entire length TL of the zoom optical system, and for defining a suitable range. The entire length TL of the zoom optical system may be the entire length (TLw) of the zoom optical system in the wide angle end state, or the entire length (TLt) of the zoom optical system in the telephoto end state. When the zoom optical system ZL satisfies the conditional expression (14), it is possible to realize the zoom optical system having high optical performance while achieving size reduction. To secure effects by the present embodiment, a lower limit value of the conditional expression (14) is preferably set to 0.09 or 0.10. In addition, an upper limit value of the conditional expression (14) is preferably set to, for example, 0.17 or 0.13.

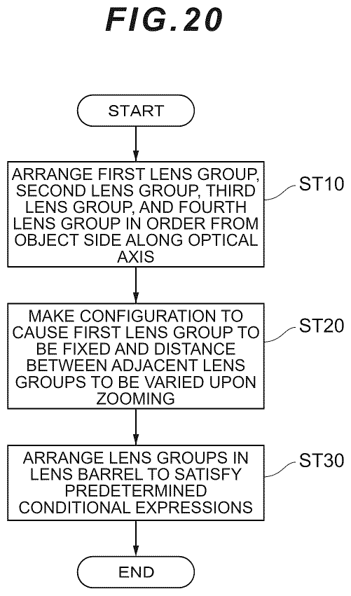

A method for manufacturing the zoom optical system ZL having the above-described configuration is described with reference to FIG. 20. First, the first lens group having the negative refractive power, the second lens group having the positive refractive power, the third lens group having the negative refractive power, and the fourth lens group having the positive refractive power are arranged in order from the object side along the optical axis (step ST10), and a configuration is made such that the first lens group is fixed relative to the image surface and the distance between adjacent lens groups is varied upon zooming (step ST20). Thereafter, the lenses are arranged in a lens barrel so as to satisfy at least the conditional expressions (1) and (2) (step ST30). By such a manufacturing method, it is possible to realize the zoom optical system ZL having excellent optical performance while achieving size reduction.

### EXAMPLES

Hereinafter, zoom optical systems ZL according to examples of the present embodiment are described with reference to drawings. FIG. 1, FIG. 4, FIG. 7, FIG. 10, FIG. 13, and FIG. 16 are cross-sectional views illustrating configurations and refractive power distributions of zoom optical systems ZL {ZL(1) to ZL(6)} according to first to sixth examples. The first to sixth examples are examples corresponding to the present embodiment, and in each diagram, a moving direction along the optical axis, of each lens group moving upon zooming from the wide angle end state (W) to the telephoto end state (T) is indicated by an arrow. Further, a lens group moving upon focusing from the infinity object to the short-distance object is referred to as a focusing lens group GF, and a moving direction thereof is indicated by an arrow with characters “FOCUSING”. At least a part of the second lens group configures a vibration-proof lens group GVR movable in a direction perpendicular to the optical axis, and corrects displacement of an image forming position (image blur on image surface I) caused by hand shake and the like. A moving direction of the vibration-proof lens group for correcting the image blur is indicated by an arrow with characters “VIBRATION-PROOF”.

In these diagrams (FIG. 1, FIG. 4, FIG. 7, FIG. 10, FIG. 13, and FIG. 16), each lens group is represented by a combination of a symbol G and a numeral, and each lens is represented by a combination of a symbol L and a numeral. In this case, to prevent the number of types and the numbers of symbols and numerals from being increased and complicated, the lens groups and the like are represented using combinations of symbols and numerals independently among the examples. Therefore, even when the same combinations of symbols and numerals are used among the examples, this does not mean the same configuration. A symbol (+) or (−) attached to each of the lens group symbol indicates a refractive power of each lens group, and the same applies to the following all examples.

Tables 1 to 6 are illustrated below. Among them, Table 1 is a table showing various data in the first example, Table 2 is a table showing various data in the second example, Table 3 is a table showing various data in the third example, Table 4 is a table showing various data in the fourth example, Table 5 is a table showing various data in the fifth example, and Table 6 is a table showing various data in the sixth example. In each of the examples, d-line (wavelength)=587.6 nm), and g-line (wavelength λ=435.8 nm) are selected as calculation targets of aberration characteristics.

In the table of [General Data], f indicates the focal length of an entire optical system, FNO indicates a F-number, @ indicates a half angle of view (unit is ° (degrees)), and Y indicates an image height. TL indicates the entire length of the optical system, and more specifically, indicates a distance obtained by adding BF to a distance from the lens foremost surface to the lens last surface on the optical axis upon focusing on infinity, and BF indicates an air equivalent distance (back focus) from the lens last surface to the image surface I on the optical axis upon focusing on infinity. Note that these values indicate the respective corresponding values in each of zoom states at the wide angle end (wide), the intermediate focal length (middle), and the telephoto end (tele). In the table of [General Data], fvr indicates a focal length of the vibration-proof lens group GVR.

In the table of [Lens Data], a surface number indicates an order of an optical surface from the object side along a traveling direction of the light, R indicates a radius of curvature (where surface having center of radius of curvature positioned on image side is regarded to have positive value) of each optical surface, D indicates a surface distance that is a distance from each optical surface to a next optical surface (or image surface) on the optical axis, and nd indicates a refractive index of a material of an optical member for d-line. The radius of curvature “o” indicates a flat surface or an aperture, and (Aperture Stop S) indicates an aperture stop. Description of an air refractive index nd=1.00000 is omitted. In a case where the lens surface is an aspherical surface, the surface number is assigned with a symbol *, and a paraxial radius of curvature is described in a field of the radius of curvature R.

In the table of [Aspherical Surface Data], the shape of the aspherical surface described in [Lens Data] is represented by the following expression (A). X(y) indicates a distance (sag amount) from a tangent plane at a vertex of the aspherical surface to a position on the aspherical surface at a height y along the optical axis direction, R indicates a radius of curvature (paraxial radius of curvature) of a reference spherical surface, K indicates a conic constant, and Ai indicates an i-th order aspherical coefficient. “E-n” indicates “×10⁻ⁿ”. For example, 1.234E-05=1.234×10⁻⁵. Note that a second-order aspherical coefficient A2 is zero, and its description is omitted.

$$X ( y ) = ( {y}^{2} / R ) / \{ 1 + {( 1 - κ \times {y}^{2} / {R}^{2} )}^{1 / 2} \} + A 4 \times {y}^{4} + A 6 \times {y}^{6} + A 8 \times {y}^{8} + A 10 \times {y}^{10} + A 12 \times {y}^{12} \qquad ( A )$$

The table of [Lens Group Data] shows a focal length of each lens group.

The table of [Variable Distance Data] shows the surface distance at each surface number in which the surface distance is “Variable” in the table showing [Lens Data]. Here, a surface distance in each of the zoom states at the wide angle end (wide), the intermediate focal length (middle), and the telephoto end (tele) upon focusing on infinity and a short-distance object is shown. In [Variable Distance Data], f indicates a focal length of the entire optical system.

The table of [Conditional Expression Corresponding Value] shows values corresponding to each of the conditional expressions.

In the following, for all the data values, “mm” is generally used for the listed focal length f, radius of curvature R, surface distance D, other lengths, and the like unless otherwise specified; however, this is not limitative because the optical system can achieve equivalent optical performance even when being proportionally enlarged or reduced.

Description of the tables so far is common to all the examples, and hereinafter, redundant description is omitted.

### First Example

A first example is described with reference to FIG. 1 to FIG. 3 and Table 1. FIG. 1 is a lens configuration diagram of the zoom optical system ZL(ZL(1)) according to the first example in the wide angle end state. The zoom optical system ZL(1) according to the first example comprises, in order from the object side along the optical axis, a first lens group G1 having a negative refractive power, a second lens group G2 having a positive refractive power, a third lens group G3 a negative refractive power, and a fourth lens group G4 having a positive refractive power.

Upon zooming from the wide angle end state to the telephoto end state, the second lens group G2 and the third lens group G3 are moved along different trajectories on the optical axis so as to reduce a distance between the first lens group G1 and the second lens group G2 and to increase a distance between the third lens group G3 and the fourth lens group G4. More specifically, upon zooming, the second lens group G2 is monotonously moved toward the object along the optical axis, the third lens group G3 is monotonously moved toward the object along the optical axis, and the first lens group G1 and the fourth lens group G4 are fixed.

The first lens group G1 includes, in order from the object side along the optical axis, a meniscus positive lens L11 having a convex surface facing the object, a meniscus negative lens L12 having a convex surface facing the object, a biconcave negative lens L13, and a meniscus positive lens L14 having a convex surface facing the object.

The second lens group G2 includes, in order from the object side along the optical axis, a biconvex positive lens L21, a meniscus positive lens L22 having a convex surface facing the object, a biconcave negative lens L23, an aperture stop S, a biconvex positive lens L24, a meniscus negative lens L25 having a convex surface facing the image surface, and a meniscus positive lens L26 having a concave surface facing the object. The positive lens L24 and the negative lens L25 are joined with each other to form a cemented lens.

The third lens group G3 includes a biconcave negative lens L31. The fourth lens group G4 includes a positive lens L41 having a convex surface facing the image surface. The image surface I is disposed on the image side of the fourth lens group.

The aperture stop S for adjusting a light quantity is disposed in the second lens group, and upon zooming from the wide angle end state to the telephoto end state, the aperture stop S is moved along the same trajectory as the second lens group G2. The lenses disposed on the image surface side of the aperture stop S in the second lens group G2 configure the vibration-proof lens group GVR movable in the direction perpendicular to the optical axis, thereby correcting displacement of the image forming position (image blur on image surface I) caused by hand shake and the like. In this example, the cemented lens including the positive lens L24 and the negative lens L25 in the second lens group G2 configures the vibration-proof lens group GVR. In addition, in this example, the third lens group G3 corresponds to the focusing lens group GF moved along the optical axis. Upon focusing from the infinity object to the short-distance object, the focusing lens group GF is moved toward the image surface along the optical axis.

Table 1 shows various data according to the first example. In the first example, a lens surface of a 19-th surface is formed in an aspherical surface shape.

TABLE 1
[General Data]
Zooming ratio = 2.197
fvr = 32.200

| | wide | middle | tele |
|---|---|---|---|
| f | 12.36 | 18.00 | 27.16 |
| FNO | 3.64 | 4.58 | 5.73 |
| ω | 53.57 | 39.74 | 27.44 |
| Y | 14.25 | 14.25 | 14.25 |
| TL | 77.25 | 77.25 | 77.25 |

[Lens Data]

| Surface | | | |
|---|---|---|---|
| number | R | D | nd |
| 1 | 66.4503 | 4.050 | 1.51680 |
| 2 | 238.3020 | 0.100 | |
| 3 | 46.6160 | 1.700 | 1.80400 |
| 4 | 13.2990 | 7.200 | |
| 5 | −466.4671 | 1.400 | 1.80400 |
| 6 | 13.2979 | 3.000 | |
| 7 | 18.3550 | 2.850 | 1.84666 |
| 8 | 56.2992 | D1(Variable) | |
| 9 | 71.8433 | 2.140 | 1.51680 |
| 10 | −22.6664 | 0.100 | |
| 11 | 11.7967 | 1.850 | 1.60342 |
| 12 | 32.0363 | 0.410 | |
| 13 | −827.1325 | 0.950 | 1.84666 |
| 14 | 30.6444 | 1.700 | |
| 15 | ∞ | 3.200 | (Aperture |
| | | | Stop) |
| 16 | 22.3289 | 3.000 | 1.49782 |
| 17 | −12.1747 | 1.000 | 1.95000 |
| 18 | −20.6586 | 4.250 | |
| 19* | −31.4221 | 1.300 | 1.58913 |
| 20 | −20.3664 | D2(Variable) | |
| 21 | −32.0982 | 1.000 | 1.80610 |
| 22 | 32.0982 | D3(Variable) | |
| 23 | −163.0228 | 3.800 | 1.85026 |
| 24 | −30.7917 | BF | |

[Aspherical surface data]
19th surface
κ = 0.0000, A4 = −1.66060E−04, A6 = 2.26257E−06,
A8 = −2.73958E−07, A10 = 1.18829E−08, A12 = −2.09340E−10
[Variable distance data]

| | wide | middle | tele |
|---|---|---|---|
| f | 12.360 | 18.000 | 27.160 |
| D1 | 15.974 | 9.269 | 2.039 |
| D2 | 3.114 | 4.126 | 8.012 |
| D3 | 3.350 | 9.043 | 12.387 |
| BF | 9.815 | 9.815 | 9.815 |

[Lens group data]
f1 = −15.547
f2 = 16.888
f3 = −19.772
f4 = 44.065

As described above, in this example, it is found that the above-described conditional expressions (1) to (14) are all satisfied.

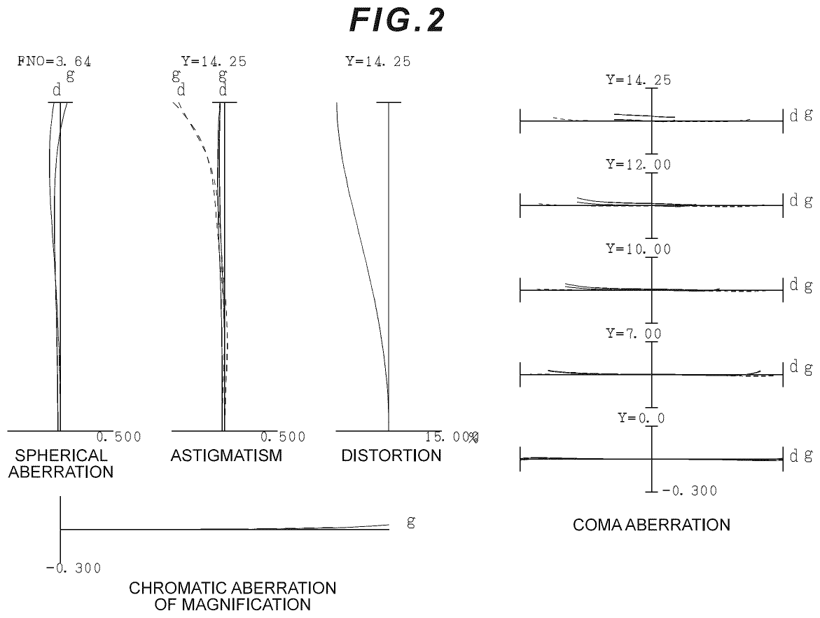

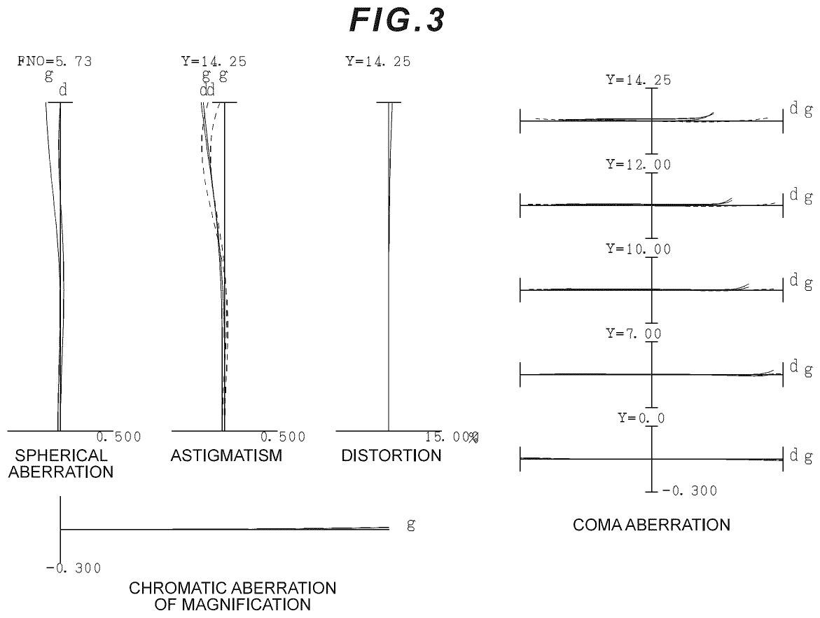

FIG. 2 and FIG. 3 are graphs illustrating various aberrations of the zoom optical system ZL(1) according to the first example. FIG. 2 is a graph illustrating various aberrations upon focusing on infinity in the wide angle end state (f=12.36 mm), and FIG. 3 is a graph illustrating various aberrations upon focusing on infinity in the telephoto end state (f=27.16 mm). In each of the aberration graphs, FNO indicates the F-number, and Y indicates the image height. Further, in each of the aberration graphs, d indicates aberration for d-line (λ=587.6 nm), and g indicates aberration for g-line (λ=435.8 nm). In the aberration graphs showing astigmatism, a solid line indicates a sagittal image surface, and a dashed line indicates a meridional image surface. In the aberration graphs showing coma aberration, meridional coma is illustrated. Description of the aberration graphs are common to the other examples.

It is found from the aberration graphs that, in the first example, in each of the focal length states from the wide angle end state to the telephoto end state, various aberrations are sufficiently corrected, and excellent optical performance is achieved. As a result, an optical device such as a camera can secure excellent optical performance by being mounted with the zoom optical system ZL(1) according to the first example.

### Second Example

A second example is described with reference to FIG. 4 to FIG. 6 and Table 2. FIG. 4 is a lens configuration diagram of the zoom optical system ZL(ZL(2)) according to the second example in the wide angle end state. The zoom optical system ZL(2) according to the second example comprises, in order from the object side along the optical axis, a first lens group G1 having a negative refractive power, a second lens group G2 having a positive refractive power, a third lens group G3 having a negative refractive power, and a fourth lens group G4 having a positive refractive power.

Upon zooming from the wide angle end state to the telephoto end state, the second lens group G2 and the third lens group G3 are moved along different trajectories on the optical axis so as to reduce a distance between the first lens group G1 and the second lens group G2 and to increase a distance between the third lens group G3 and the fourth lens group G4. More specifically, upon zooming, the second lens group G2 is monotonously moved toward the object along the optical axis, the third lens group G3 is monotonously moved toward the object along the optical axis, and the first lens group G1 and the fourth lens group G4 are fixed.

The first lens group G1 includes, in order from the object side along the optical axis, a meniscus positive lens L11 having a convex surface facing the object, a meniscus negative lens L12 having a convex surface facing the object, a biconcave negative lens L13, and a meniscus positive lens L14 having a convex surface facing the object.

The second lens group G2 includes, in order from the object side along the optical axis, a biconvex positive lens L21, a meniscus positive lens L22 having a convex surface facing the object, an aperture stop S, a meniscus negative lens L23 having a convex surface facing the object, a biconvex positive lens L24, a biconvex positive lens L25, a biconcave negative lens L26, and a biconvex positive lens L27. The negative lens L23 and the positive lens L24 are joined with each other to form a cemented lens. The positive lens L25 and the negative lens L26 are joined with each other to form a cemented lens.

The third lens group G3 includes a biconcave negative lens L31. The fourth lens group G4 includes a positive lens L41 having a convex surface facing the image surface. The image surface I is disposed on the image side of the fourth lens group.

The aperture stop S for adjusting a light quantity is disposed in the second lens group, and upon zooming from the wide angle end state to the telephoto end state, the aperture stop S is moved along the same trajectory as the second lens group G2. The lenses disposed on the image surface side of the aperture stop S in the second lens group G2 configure the vibration-proof lens group GVR movable in the direction perpendicular to the optical axis, thereby correcting displacement of the image forming position (image blur on image surface I) caused by hand shake and the like. In this example, the cemented lens including the positive lens L25 and the negative lens L26, and the positive lens L27 configure the vibration-proof lens group GVR. The third lens group G3 corresponds to the focusing lens group GF moved along the optical axis. Upon focusing from the infinity object to the short-distance object, the focusing lens group GF is moved toward the image surface along the optical axis.

Table 2 shows various data according to the second example. In the second example, a lens surface of a 23-th surface is formed in an aspherical surface shape.

TABLE 2
[General Data]
Zooming ratio = 2.197
fvr = 22.343

| | wide | middle | tele |
|---|---|---|---|
| f | 12.36 | 18.00 | 27.16 |
| FNO | 3.65 | 4.50 | 5.87 |
| ω | 53.57 | 39.61 | 27.10 |
| Y | 14.25 | 14.25 | 14.25 |
| TL | 72.18 | 72.18 | 72.18 |

[Lens Data]

| Surface | | | |
|---|---|---|---|
| number | R | D | nd |
| 1 | 60.4368 | 3.200 | 1.51680 |
| 2 | 156.4158 | 0.100 | |
| 3 | 42.6484 | 1.800 | 1.80400 |
| 4 | 11.1065 | 6.500 | |
| 5 | −274.2551 | 1.500 | 1.77250 |
| 6 | 16.9176 | 1.315 | |
| 7 | 18.8004 | 2.400 | 1.84666 |
| 8 | 43.6513 | D1(Variable) | |
| 9 | 29.7577 | 1.600 | 1.90265 |
| 10 | −70.9552 | 0.100 | |
| 11 | 11.1451 | 1.250 | 1.80518 |
| 12 | 15.0938 | 1.200 | |
| 13 | ∞ | 1.888 | (Aperture |
| | | | Stop) |
| 14 | 49.5741 | 0.800 | 1.90200 |
| 15 | 8.9529 | 2.300 | 1.48749 |
| 16 | −37.3924 | 0.800 | |
| 17 | 17.5201 | 2.700 | 1.49700 |
| 18 | −9.4712 | 0.800 | 1.84666 |
| 19 | 19.2835 | 1.000 | |
| 20 | 28.2000 | 2.800 | 1.92286 |
| 21 | −15.6124 | D2(Variable) | |
| 22 | −20.6522 | 1.000 | 1.85207 |
| 23* | 38.4286 | D3(Variable) | |
| 24 | −211.5502 | 3.500 | 1.80400 |
| 25 | −30.1380 | BF | |

[Aspherical surface data]
23rd surface
κ = 0.0000, A4 = 7.43737E−05, A6 = −3.42988E−07,
A8 = 3.02187E−09, A10 = −6.08064E−12, A12 = 0.00000E+00
[Variable distance data]

| | wide | middle | tele |
|---|---|---|---|
| f | 12.360 | 18.000 | 27.160 |
| D1 | 15.865 | 9.425 | 2.755 |
| D2 | 2.878 | 4.255 | 7.944 |
| D3 | 3.311 | 8.373 | 11.355 |
| BF | 11.573 | 11.573 | 11.573 |

[Lens group data]
f1 = −13.807
f2 = 15.155
f3 = −15.643
f4 = 43.340

As described above, in this example, it is found that the above-described conditional expressions (1) to (14) are all satisfied.

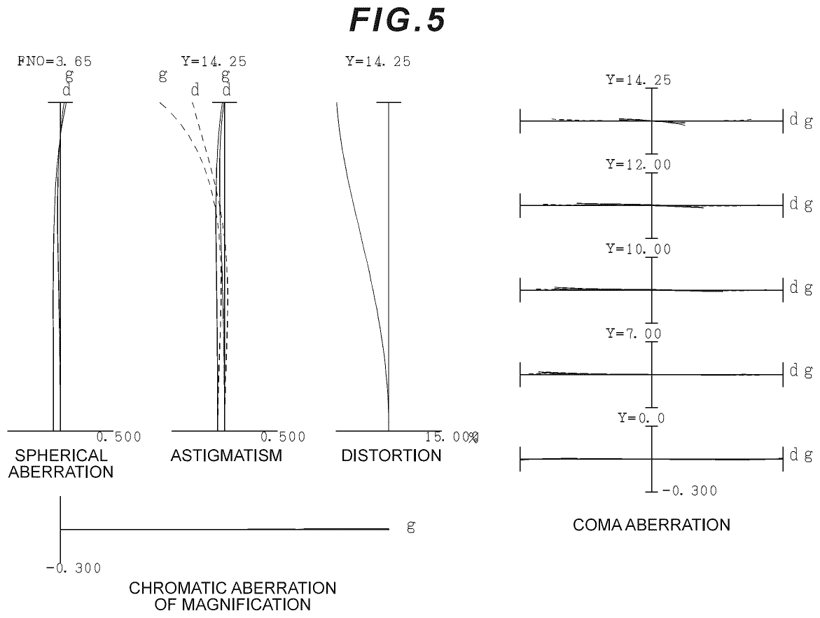

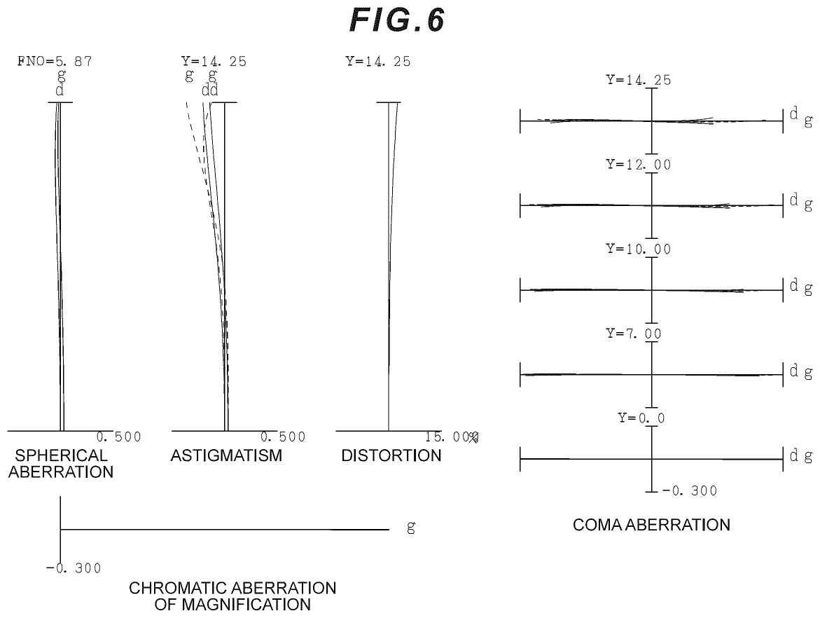

FIG. 5 and FIG. 6 are graphs illustrating various aberrations of the zoom optical system according to the second example upon focusing on infinity in the wide angle end state (f=12.36 mm) and in the telephoto end state (f=27.16 mm), respectively. It is found from the aberration graphs that, in the second example, in each of the focal length states from the wide angle end state to the telephoto end state, various aberrations are sufficiently corrected, and excellent optical performance is achieved. As a result, an optical device such as a camera can secure excellent optical performance by being mounted with the zoom optical system ZL(2) according to the second example.

### Third Example

A third example is described with reference to FIG. 7 to FIG. 9 and Table 3. FIG. 7 is a lens configuration diagram of the zoom optical system ZL(ZL(3)) according to the third example in the wide angle end state. The zoom optical system ZL(3) according to the third example comprises, in order from the object side along the optical axis, a first lens group G1 having a negative refractive power, a second lens group G2 having a positive refractive power, a third lens group G3 having a negative refractive power, and a fourth lens group G4 having a positive refractive power.

Upon zooming from the wide angle end state to the telephoto end state, the second lens group G2 and the third lens group G3 are moved along different trajectories on the optical axis so as to reduce a distance between the first lens group G1 and the second lens group G2 and to increase a distance between the third lens group G3 and the fourth lens group G4. More specifically, upon zooming, the second lens group G2 is monotonously moved toward the object along the optical axis, the third lens group G3 is monotonously moved toward the object along the optical axis, and the first lens group G1 and the fourth lens group G4 are fixed.

The first lens group G1 includes, in order from the object side along the optical axis, a meniscus first positive lens L11 having a convex surface facing the object, a meniscus second negative lens L12 having a convex surface facing the object, a biconcave third negative lens L13, and a meniscus fourth positive lens L14 having a convex surface facing the object.

The second lens group G2 includes, in order from the object side along the optical axis, a meniscus positive lens L21 having a convex surface facing the object, a biconcave negative lens L22, a biconvex positive lens L23, an aperture stop S, a meniscus negative lens L24 having a convex surface facing the object, a meniscus positive lens L25 having a convex surface facing the object, and a biconvex positive lens L26. The negative lens L22 and the positive lens L23 are joined with each other to form a cemented lens. The negative lens L24 and the positive lens L25 are joined with each other to form a cemented lens.

The third lens group G3 includes a biconcave negative lens L31. The fourth lens group G4 includes a positive lens L41 having a convex surface facing the image surface. The image surface I is disposed on the image side of the fourth lens group.

The aperture stop S for adjusting a light quantity is disposed in the second lens group, and upon zooming from the wide angle end state to the telephoto end state, the aperture stop S is moved along the same trajectory as the second lens group G2. The lenses disposed on the image surface side of the aperture stop S in the second lens group G2 configure the vibration-proof lens group GVR movable in the direction perpendicular to the optical axis, thereby correcting displacement of the image forming position (image blur on image surface I) caused by hand shake and the like. In this example, the cemented lens in which the negative lens L24 and the positive lens L25 are joined with each other, and the biconvex positive lens L26 in the second lens group G2 configure the vibration-proof lens group GVR. In this example, the third lens group G3 corresponds to the focusing lens group GF moved along the optical axis. Upon focusing from the infinity object to the short-distance object, the focusing lens group GF is moved toward the image surface along the optical axis.

Table 3 shows various data according to the third example. In the third example, a lens surface of a 21-th surface is formed in an aspherical surface shape.

TABLE 3
[General Data]
Zooming ratio = 2.197
fvr = 26.382

| | wide | middle | tele |
|---|---|---|---|
| f | 12.36 | 18.00 | 27.16 |
| FNO | 3.64 | 4.57 | 5.72 |
| ω | 53.27 | 39.78 | 27.08 |
| Y | 14.25 | 14.25 | 14.25 |
| TL | 77.38 | 77.38 | 77.38 |

[Lens Data]

| Surface | | | |
|---|---|---|---|
| number | R | D | nd |
| 1 | 112.7836 | 3.500 | 1.51680 |
| 2 | 451.6206 | 0.100 | |
| 3 | 41.2119 | 2.000 | 1.80400 |
| 4 | 13.6830 | 7.500 | |
| 5 | −287.2897 | 1.700 | 1.72916 |
| 6 | 16.2042 | 2.093 | |
| 7 | 20.7036 | 2.500 | 1.92286 |
| 8 | 42.2178 | D1(Variable) | |
| 9 | 18.2931 | 2.000 | 2.00069 |
| 10 | 3296.2195 | 1.200 | |
| 11 | −46.9378 | 1.500 | 1.85000 |
| 12 | 11.2313 | 3.100 | 1.59319 |
| 13 | −25.6796 | 1.000 | |
| 14 | ∞ | 1.500 | (Aperture |
| | | | Stop) |
| 15 | 8.7922 | 1.000 | 1.95375 |
| 16 | 6.3044 | 2.500 | 1.55298 |
| 17 | 10.3875 | 2.362 | |
| 18 | 24.0628 | 2.400 | 1.69680 |
| 19 | −53.7530 | D2(Variable) | |
| 20 | −30.4597 | 1.000 | 1.85207 |
| 21* | 56.7028 | D3(Variable) | |
| 22 | 0.0000 | 3.900 | 1.95375 |
| 23 | −39.9510 | BF | |

[Aspherical surface data]
21st surface
κ = 0.0000, A4 = 8.52592E−05, A6 = −5.00692E−07,
A8 = 2.15230E−08, A10 = −6.18925E−10, A12 = 6.81140E−12
[Variable distance data]

| | wide | middle | tele |
|---|---|---|---|
| f | 12.360 | 18.000 | 27.160 |
| D1 | 16.342 | 9.543 | 2.508 |
| D2 | 3.000 | 3.997 | 7.948 |
| D3 | 5.104 | 10.905 | 13.990 |
| BF | 10.076 | 10.076 | 10.076 |

[Lens group data]
f1 = −16.310
f2 = 16.086
f3 = −23.133
f4 = 41.888

As described above, in this example, it is found that the above-described conditional expressions (1) to (14) are all satisfied.

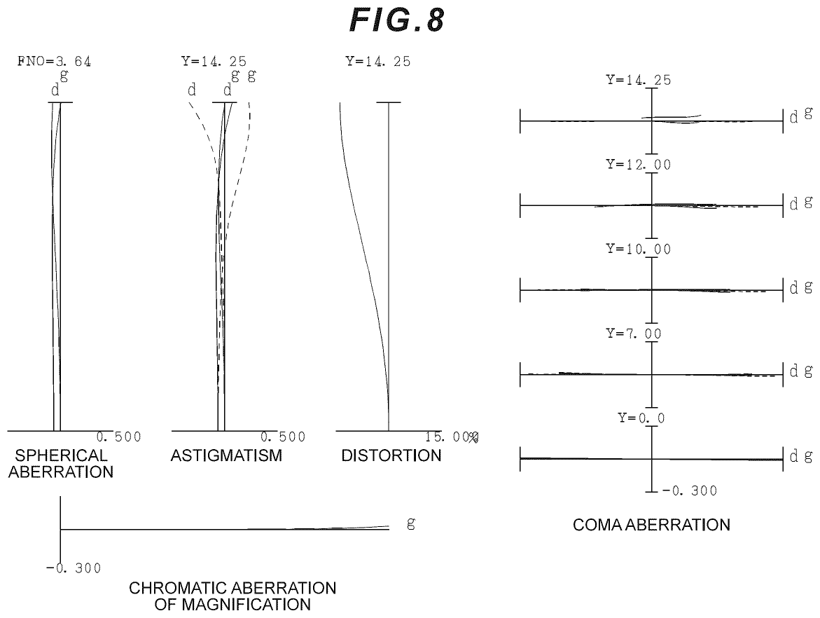

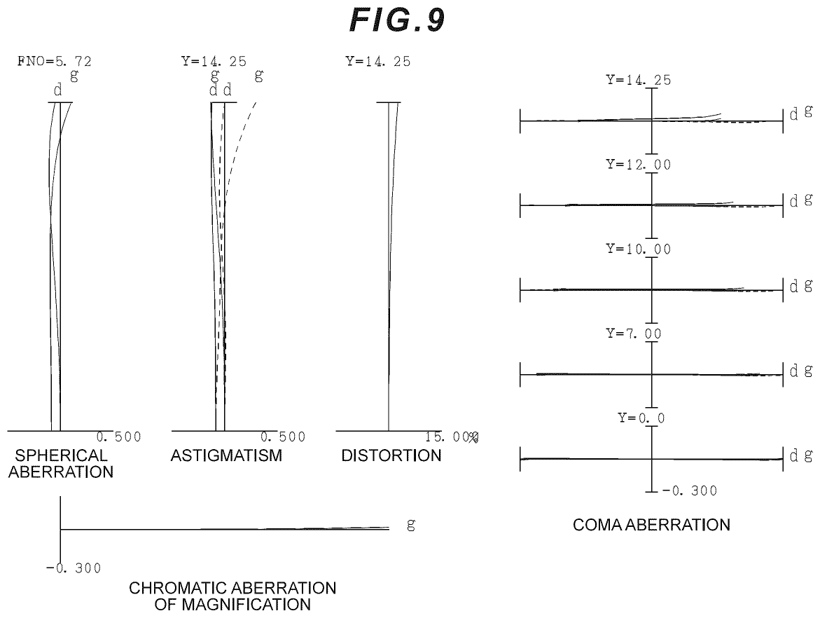

FIG. 8 and FIG. 9 are graphs illustrating various aberrations of the zoom optical system according to the third example upon focusing on infinity in the wide angle end state (f=12.36 mm) and in the telephoto end state (f=27.16 mm), respectively. It is found from the aberration graphs that, in the third example, in each of the focal length states from the wide angle end state to the telephoto end state, various aberrations are sufficiently corrected, and excellent optical performance is achieved. As a result, an optical device such as a camera can secure excellent optical performance by being mounted with the zoom optical system ZL(3) according to the third example.

### Fourth Example

A fourth example is described with reference to FIG. 10 to FIG. 12 and Table 4. FIG. 10 is a lens configuration diagram of the zoom optical system ZL(ZL(4)) according to the fourth example in the wide angle end state. The zoom optical system ZL(4) according to the fourth example comprises, in order from the object side along the optical axis, a first lens group G1 having a negative refractive power, a second lens group G2 having a positive refractive power, a third lens group G3 having a negative refractive power, and a fourth lens group G4 having a positive refractive power.

Upon zooming from the wide angle end state to the telephoto end state, the second lens group G2 and the third lens group G3 are moved along different trajectories on the optical axis so as to reduce a distance between the first lens group G1 and the second lens group G2 and to increase a distance between the third lens group G3 and the fourth lens group G4. More specifically, upon zooming, the second lens group G2 is monotonously moved toward the object along the optical axis, the third lens group G3 is monotonously moved toward the object along the optical axis, and the first lens group G1 and the fourth lens group G4 are fixed.

The first lens group G1 includes, in order from the object side along the optical axis, a meniscus positive lens L11 having a convex surface facing the object, a meniscus negative lens L12 having a convex surface facing the object, a biconcave negative lens L13, and a meniscus positive lens L14 having a convex surface facing the object.

The second lens group G2 includes, in order from the object side along the optical axis, a biconvex positive lens L21, a meniscus positive lens L22 having a convex surface facing the object, a meniscus negative lens L23 having a convex surface facing the image surface, an aperture stop S, a biconvex positive lens L24, a meniscus negative lens L25 having a convex surface facing the image surface, and a meniscus positive lens L26 having a convex surface facing the image surface. The positive lens L24 and the negative lens L25 are joined with each other to form a cemented lens.

The third lens group G3 includes a biconcave negative lens L31. The fourth lens group G4 includes a positive lens L41 having a convex surface facing the image surface. The image surface I is disposed on the image side of the fourth lens group.

The aperture stop S for adjusting a light quantity is disposed in the second lens group, and upon zooming from the wide angle end state to the telephoto end state, the aperture stop S is moved along the same trajectory as the second lens group G2. The lenses disposed on the image surface side of the aperture stop S in the second lens group G2 configure the vibration-proof lens group GVR movable in the direction perpendicular to the optical axis, thereby correcting displacement of the image forming position (image blur on image surface I) caused by hand shake and the like. In this example, the cemented lens in which the positive lens L24 and the negative lens L25 are joined with each other in the second lens group G2 configures the vibration-proof lens group GVR. In this example, the third lens group G3 corresponds to the focusing lens group GF moved along the optical axis. Upon focusing from the infinity object to the short-distance object, the focusing lens group GF is moved toward the image surface along the optical axis.

Table 4 shows various data according to the fourth example. In the fourth example, a lens surface of a 19-th surface is formed in an aspherical surface shape.

TABLE 4
[General Data]
Zooming ratio = 2.197
fvr = 30.173

| | wide | middle | tele |
|---|---|---|---|
| f | 12.36 | 18.00 | 27.16 |
| FNO | 3.64 | 4.58 | 5.73 |
| ω | 53.41 | 39.52 | 27.30 |
| Y | 14.25 | 14.25 | 14.25 |
| TL | 76.94 | 76.94 | 76.94 |

[Lens Data]

| Surface | | | |
|---|---|---|---|
| number | R | D | nd |
| 1 | 64.9470 | 3.700 | 1.51680 |
| 2 | 174.2426 | 0.100 | |
| 3 | 36.3524 | 1.700 | 1.80400 |
| 4 | 13.0134 | 7.000 | |
| 5 | −307.5327 | 1.400 | 1.80400 |
| 6 | 14.2032 | 3.431 | |
| 7 | 19.9370 | 2.500 | 1.84666 |
| 8 | 55.4623 | D1(Variable) | |
| 9 | 16.3449 | 2.300 | 1.51680 |
| 10 | −27.7612 | 0.100 | |
| 11 | 18.6638 | 1.200 | 1.62004 |
| 12 | 25.5403 | 1.200 | |
| 13 | −26.1739 | 0.800 | 1.95000 |
| 14 | −88.0914 | 1.012 | |
| 15 | ∞ | 3.600 | (Aperture |
| | | | Stop) |
| 16 | 21.4886 | 3.000 | 1.49782 |
| 17 | −11.3638 | 0.800 | 1.85026 |
| 18 | −20.5601 | 4.127 | |
| 19* | −64.5187 | 1.000 | 1.77541 |
| 20 | −39.9346 | D2(Variable) | |
| 21 | −21.8343 | 1.000 | 1.60342 |
| 22 | 27.9575 | D3(Variable) | |
| 23 | 216.1889 | 4.000 | 1.90265 |
| 24 | −41.8719 | BF | |

[Aspherical surface data]
19th surface
κ = 0.0000, A4 = −1.16050E−04, A6 = 1.68584E−06,
A8 = −1.57438E−07, A10 = 5.49231E−09, A12 = −7.64340E−11
[Variable distance data]

| | wide | middle | tele |
|---|---|---|---|
| f | 12.360 | 18.000 | 27.160 |
| D1 | 16.697 | 9.820 | 2.492 |
| D2 | 2.770 | 3.840 | 7.749 |
| D3 | 3.971 | 9.778 | 13.198 |
| BF | 9.528 | 9.528 | 9.528 |

[Lens group data]
f1 = −16.135
f2 = 16.958
f3 = −20.165
f4 = 39.149

As described above, in this example, it is found that the above-described conditional expressions (1) to (14) are all satisfied.

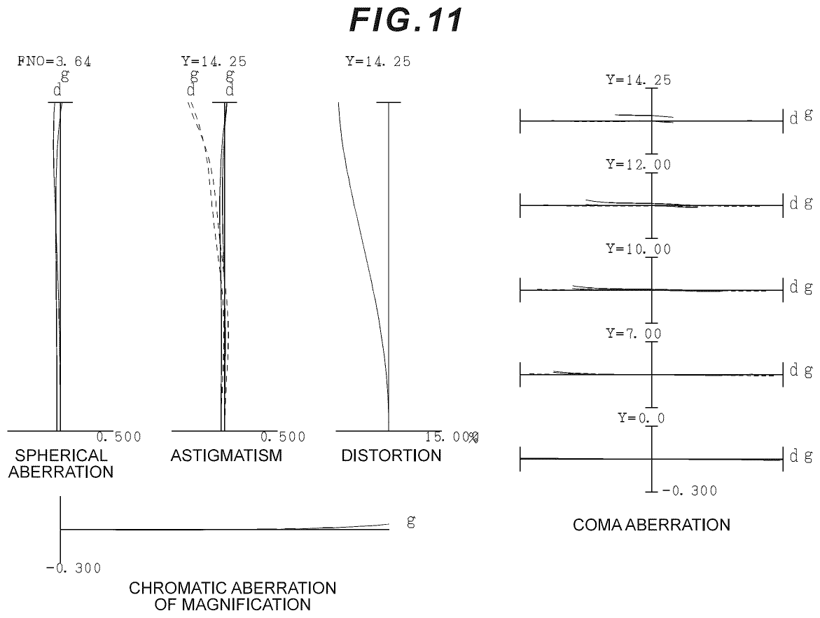

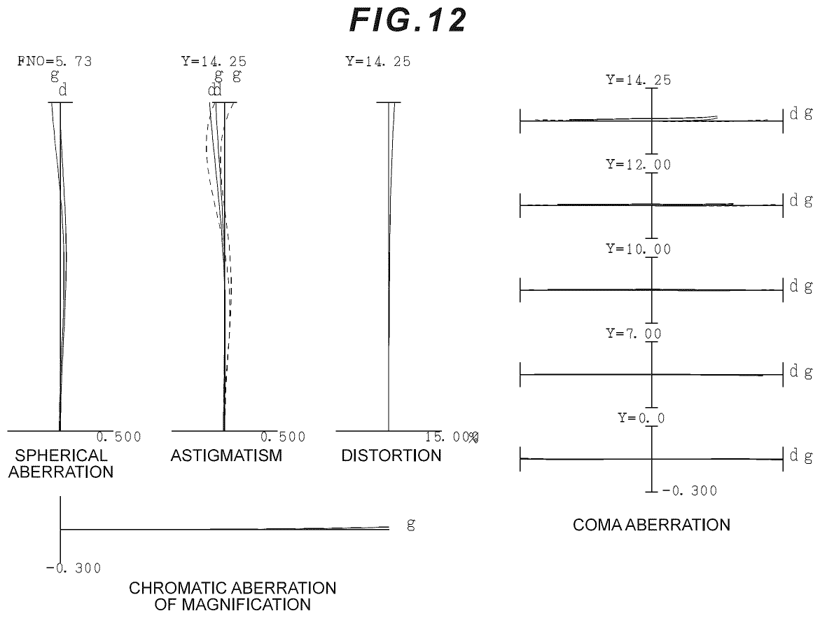

FIG. 11 and FIG. 12 are graphs illustrating various aberrations of the zoom optical system according to the fourth example upon focusing on infinity in the wide angle end state (f=12.36 mm) and in the telephoto end state (f=27.16 mm), respectively. It is found from the aberration graphs that, in the fourth example, in each of the focal length states from the wide angle end state to the telephoto end state, various aberrations are sufficiently corrected, and excellent optical performance is achieved. As a result, an optical device such as a camera can secure excellent optical performance by being mounted with the zoom optical system ZL(4) according to the fourth example.

### Fifth Example

A fifth example is described with reference to FIG. 13 to FIG. 15 and Table 5. FIG. 13 is a lens configuration diagram of the zoom optical system ZL(ZL(5)) according to the fifth example in the wide angle end state. The zoom optical system ZL(5) according to the fifth example comprises, in order from the object side along the optical axis, a first lens group G1 having a negative refractive power, a second lens group G2 having a positive refractive power, a third lens group G3 having a negative refractive power, and a fourth lens group G4 having a positive refractive power.

Upon zooming from the wide angle end state to the telephoto end state, the second lens group G2 and the third lens group G3 are moved along different trajectories on the optical axis so as to reduce a distance between the first lens group G1 and the second lens group G2 and to increase a distance between the third lens group G3 and the fourth lens group G4. More specifically, upon zooming, the second lens group G2 is monotonously moved toward the object along the optical axis, the third lens group G3 is monotonously moved toward the object along the optical axis, and the first lens group G1 and the fourth lens group G4 are fixed.

The first lens group G1 includes, in order from the object side along the optical axis, a meniscus negative lens L11 having a convex surface facing the object, a meniscus negative lens L12 having a convex surface facing the object, and a meniscus positive lens L13 having a convex surface facing the object. The negative lens L11 is a hybrid lens in which a resin layer is provided on the image surface side of a lens main body made of glass. A surface of the resin layer on the image surface side is an aspherical surface, and the negative lens L11 is a composite aspherical surface lens. In [Lens Data] described below, a surface number 1 indicates a surface of the lens main body on the object side, a surface number 2 indicates a surface of the lens main body on the image surface side and a surface of the resin layer on the object side (both surfaces are joined), and a surface number 3 indicates a surface of the resin layer on the image surface side.

The second lens group G2 includes, in order from the object side along the optical axis, a biconvex positive lens L21, a meniscus negative lens L22 having a convex surface facing the object, a biconvex positive lens L23, an aperture stop S, a meniscus negative lens L24 having a convex surface facing the object, a biconvex positive lens L25, and a biconvex positive lens L26. The negative lens L22 and the positive lens L23 are joined with each other to form a cemented lens. The negative lens L24 and the positive lens L25 are joined with each other to form a cemented lens.

The third lens group G3 includes a meniscus negative lens L31 having a convex surface facing the object. The fourth lens group G4 includes a positive lens L41 having a convex surface facing the image surface. The image surface I is disposed on the image side of the fourth lens group.

The aperture stop S for adjusting a light quantity is disposed in the second lens group, and upon zooming from the wide angle end state to the telephoto end state, the aperture stop S is moved along the same trajectory as the second lens group G2. The lenses disposed on the image surface side of the aperture stop S in the second lens group G2 configure the vibration-proof lens group GVR movable in the direction perpendicular to the optical axis, thereby correcting displacement of the image forming position (image blur on image surface I) caused by hand shake and the like. In this example, the cemented lens in which the negative lens L24 and the positive lens L25 are joined with each other, and the positive lens L26 in the second lens group G2 configure the vibration-proof lens group GVR. In this example, the third lens group G3 corresponds to the focusing lens group GF moved along the optical axis. Upon focusing from the infinity object to the short-distance object, the focusing lens group GF is moved toward the image surface along the optical axis.

Table 5 shows various data according to the fifth example. In the fifth example, a lens surface of each of a third surface, an eighth surface, and a 19-th surface is formed in an aspherical surface shape.

TABLE 5
[General Data]
Zooming ratio = 2.635
fvr = 25.469

| | wide | middle | tele |
|---|---|---|---|
| f | 10.31 | 20.00 | 27.16 |
| FNO | 3.55 | 5.42 | 6.47 |
| ω | 57.22 | 35.33 | 26.86 |
| Y | 14.25 | 14.25 | 14.25 |
| TL | 76.51 | 76.51 | 76.51 |

[Lens Data]

| Surface | | | |
|---|---|---|---|
| number | R | D | nd |
| 1 | 55.6630 | 2.000 | 1.80400 |
| 2 | 13.2000 | 0.090 | 1.56093 |
| 3* | 9.6573 | 9.991 | |
| 4 | 47.9718 | 1.500 | 1.49782 |
| 5 | 15.1607 | 1.634 | |
| 6 | 16.6639 | 2.300 | 2.00069 |
| 7 | 24.0080 | D1(Variable) | |
| 8* | 13.5488 | 1.800 | 1.69370 |
| 9 | −265.5870 | 4.099 | |
| 10 | 184.9248 | 0.800 | 1.83481 |
| 11 | 9.4820 | 1.800 | 1.49782 |
| 12 | −47.1263 | 1.200 | |
| 13 | ∞ | 1.500 | (Aperture |
| | | | Stop) |
| 14 | 13.6358 | 0.800 | 1.80440 |
| 15 | 8.6913 | 1.500 | 1.49782 |
| 16 | 67.1279 | 2.000 | |
| 17 | 90.1169 | 1.200 | 1.60300 |
| 18 | −34.7620 | D2(Variable) | |
| 19* | 849.1048 | 1.000 | 1.80139 |
| 20 | 19.9905 | D3(Variable) | |
| 21 | −171.3125 | 3.000 | 1.77250 |
| 22 | −34.4365 | BF | |

[Aspherical surface data]
3rd surface
κ = −1.0000, A4 = 4.57524E−05, A6 = 5.67822E−08,
A8 = −2.71480E−10, A10 = 6.14646E−12, A12 = −2.71780E−14
8th surface
κ = 0.0000, A4 = −3.57723E−05, A6 = −1.06964E−07,
A8 = 8.50140E−11, A10 = −3.35939E−11, A12 = 0.00000E+00
19th surface
κ = 0.0000, A4 = −6.87936E−05, A6 = 6.63289E−07,
A8 = −1.73689E−08, A10 = 2.31023E−10, A12 = 0.00000E+00
[Variable distance data]

| | wide | middle | tele |
|---|---|---|---|
| f | 10.308 | 20.000 | 27.160 |
| D1 | 38.940 | 25.674 | 20.037 |
| D2 | 13.551 | 15.174 | 18.562 |
| D3 | 6.241 | 17.884 | 20.133 |
| BF | 11.805 | 11.805 | 11.805 |

[Lens group data]
f1 = −15.485
f2 = 17.203
f3 = −25.560
f4 = 55.265

As described above, in this example, it is found that the above-described conditional expressions (1) to (14) are all satisfied.

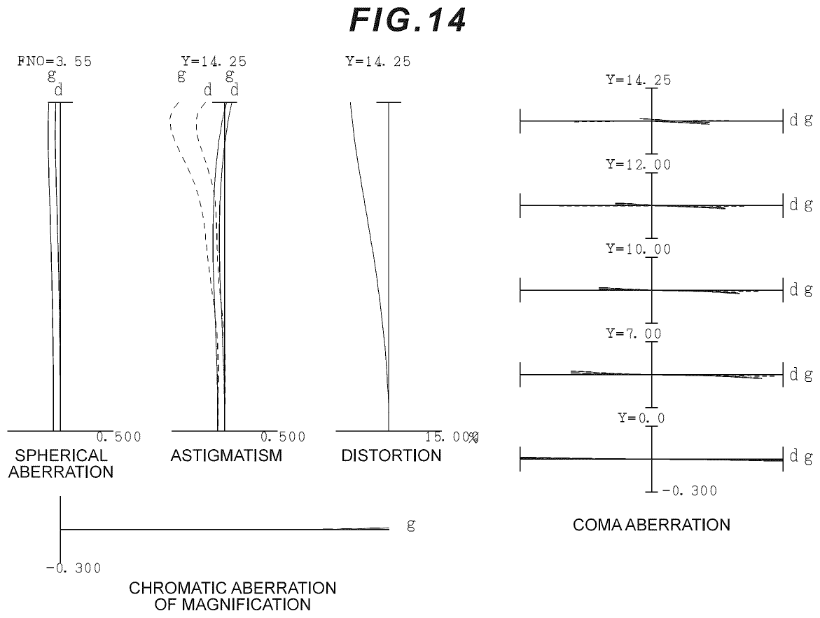

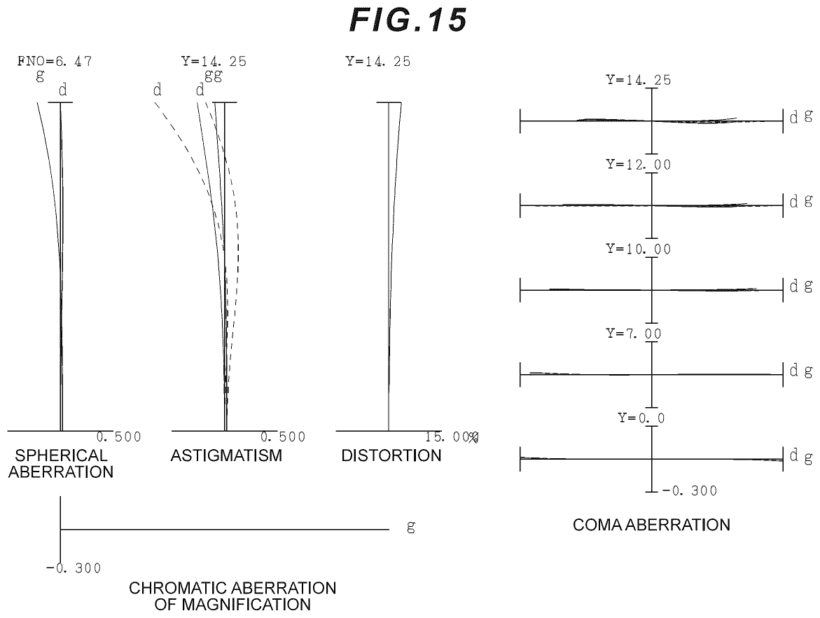

FIG. 14 and FIG. 15 are graphs illustrating various aberrations of the zoom optical system according to the fifth example upon focusing on infinity in the wide angle and state (f=10.31 mm) and in the telephoto end state (f=27.16 mm), respectively. It is found from the aberration graphs that, in the fifth example, in each of the focal length states from the wide angle end state to the telephoto end state, various aberrations are sufficiently corrected, and excellent optical performance is achieved. As a result, an optical device such as a camera can secure excellent optical performance by being mounted with the zoom optical system ZL(5) according to the fifth example.

### Sixth Example

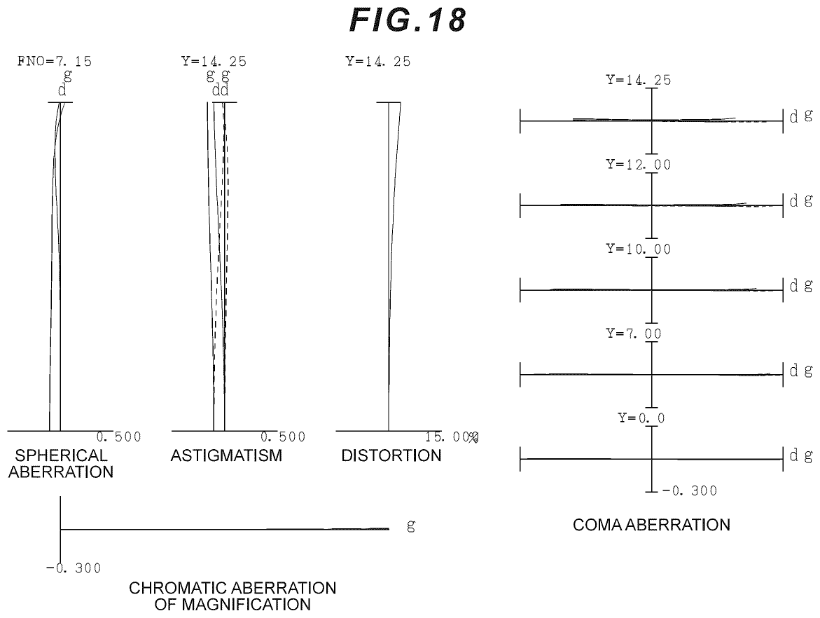

A sixth example is described with reference to FIG. 16 to FIG. 18 and Table 6. FIG. 18 is a lens configuration diagram of the zoom optical system ZL(ZL(6)) according to the sixth example in the wide angle end state. The zoom optical system ZL(6) according to the sixth example comprises, in order from the object side along the optical axis, a first lens group G1 having a negative refractive power, a second lens group G2 having a positive refractive power, a third lens group G3 having a negative refractive power, and a fourth lens group G4 having a positive refractive power.

Upon zooming from the wide angle end state to the telephoto end state, the second lens group G2 and the third lens group G3 are moved along different trajectories on the optical axis so as to reduce a distance between the first lens group G1 and the second lens group G2 and to increase a distance between the third lens group G3 and the fourth lens group G4. More specifically, upon zooming, the second lens group G2 is monotonously moved toward the object along the optical axis, the third lens group G3 is monotonously moved toward the object along the optical axis, and the first lens group G1 and the fourth lens group G4 are fixed.

The first lens group G1 includes, in order from the object side along the optical axis, a meniscus negative lens L11 having a convex surface facing the object, a biconcave negative lens L12, and a meniscus positive lens L13 having a convex surface facing the object. The negative lens L11 is a hybrid lens in which a resin layer is provided on the image surface side of a lens main body made of glass. A surface of the resin layer on the image surface side is an aspherical surface, and the negative lens L11 is a composite aspherical surface lens. In [Lens Data] described below, a surface number 1 indicates a surface of the lens main body on the object side, a surface number 2 indicates a surface of the lens main body on the image surface side and a surface of the resin layer on the object side (both surfaces are joined), and a surface number 3 indicates a surface of the resin layer on the image surface side.

The second lens group G2 includes, in order from the object side along the optical axis, a meniscus positive lens L21 having a convex surface facing the object, a meniscus negative lens L22 having a convex surface facing the object, a meniscus positive lens L23 having a convex surface facing the object, an aperture stop S, a meniscus negative lens L24 having a convex surface facing the object, a biconvex positive lens L25, and a meniscus negative lens L26 having a convex surface facing the object. The negative lens L22 and the positive lens L23 are joined with each other to form a cemented lens. The negative lens L24 and the positive lens L25 are joined with each other to form a cemented lens.

The third lens group G3 includes a biconcave negative lens L31. The fourth lens group G4 includes a positive lens L41 having a convex surface facing the image surface. The image surface I is disposed on the image side of the fourth lens group. The negative lens L31 is a hybrid lens in which a resin layer is provided on the image surface side of a lens main body made of glass. A surface of the resin layer on the image surface side is an aspherical surface, and the negative lens L31 is a composite aspherical surface lens. In [Lens Data] described below, a surface number 19 indicates a surface of the lens main body on the object side, a surface number 20 indicates a surface of the lens main body on the image surface side and a surface of the resin layer on the object side (both surfaces are joined), and a surface number 21 indicates a surface of the resin layer on the image surface side.

The aperture stop S for adjusting a light quantity is disposed in the second lens group, and upon zooming from the wide angle end state to the telephoto end state, the aperture stop S is moved along the same trajectory as the second lens group G2. The lenses disposed on the image surface side of the aperture stop S in the second lens group G2 configure the vibration-proof lens group GVR movable in the direction perpendicular to the optical axis, thereby correcting displacement of the image forming position (image blur on image surface I) caused by hand shake and the like. In this example, the cemented lens in which the negative lens L24 and the positive lens L25 are joined with each other, and the negative lens L26 in the second lens group G2 configure the vibration-proof lens group GVR. In this example, the third lens group G3 corresponds to the focusing lens group GF moved along the optical axis. Upon focusing from the infinity object to the short-distance object, the focusing lens group GF is moved toward the image surface along the optical axis.

Table 6 shows various data according to the sixth example. In the sixth example, a lens surface of each of a third surface, a 17-th surface, an 18-th surface, and a 21-th surface is formed in an aspherical surface shape.

TABLE 6
[General Data]
Zooming ratio = 2.197
fvr = 24.121

| | wide | middle | tele |
|---|---|---|---|
| f | 12.36 | 18.00 | 27.16 |
| FNO | 4.53 | 5.69 | 7.15 |
| ω | 52.46 | 38.78 | 26.90 |
| Y | 14.25 | 14.25 | 14.25 |
| TL | 69.41 | 69.41 | 69.41 |

[Lens Data]

| Surface | | | |
|---|---|---|---|
| number | R | D | nd |
| 1 | 43.0125 | 2.000 | 1.66755 |
| 2 | 12.1000 | 0.090 | 1.56093 |
| 3* | 10.7100 | 9.500 | |
| 4 | −75.7092 | 1.500 | 1.49782 |
| 5 | 16.3762 | 1.422 | |
| 6 | 21.1211 | 2.500 | 1.90366 |
| 7 | 56.1051 | D1(Variable) | |
| 8 | 32.8478 | 1.000 | 1.66755 |
| 9 | 117.4911 | 0.100 | |
| 10 | 15.3724 | 0.800 | 1.73211 |
| 11 | 6.0524 | 2.500 | 1.65844 |
| 12 | 40.0902 | 1.707 | |
| 13 | ∞ | 1.500 | (Aperture |
| | | | Stop) |
| 14 | 10.9064 | 0.800 | 1.90366 |
| 15 | 7.1553 | 2.900 | 1.49782 |
| 16 | −33.9717 | 1.733 | |
| 17* | −71.5682 | 1.200 | 1.53110 |
| 18* | −61.2117 | D2(Variable) | |
| 19 | −22.7351 | 0.750 | 1.80100 |
| 20 | 41.0445 | 0.200 | 1.56093 |
| 21* | 49.8633 | D3(Variable) | |
| 22 | −1087.0894 | 4.800 | 1.78800 |
| 23 | −30.3403 | BF | |

[Aspherical surface data]
3rd surface
κ = −1.0000, A4 = 7.27375E−05, A6 = 2.49679E−07,
A8 = −7.82392E−10, A10 = 1.38206E−11, A12 = 0.00000E+00
17th surface
κ = 0.0000, A4 = 7.95506E−04, A6 = 1.55427E−05,
A8 = −1.72626E−07, A10 = 1.40171E−09, A12 = 0.00000E+00
18th surface
κ = 0.0000, A4 = 8.39877E−04, A6 = 1.62508E−05,
A8 = 2.44509E−08, A10 = 1.12099E−09, A12 = 0.00000E+00
21st surface
κ = 0.00000, A4 = 1.79600E−04, A6 = −9.82060E−07,
A8 = 1.72937E−09, A10 = −2.07534E−10, A12 = 0.00000E+00
[Variable distance data]

| | wide | middle | tele |
|---|---|---|---|
| f | 12.360 | 18.000 | 27.160 |
| D1 | 15.018 | 8.132 | 1.009 |
| D2 | 3.000 | 3.612 | 6.122 |
| D3 | 2.800 | 9.074 | 13.688 |
| BF | 11.590 | 11.590 | 11.590 |

[Lens group data]
f1 = −17.835
f2 = 14.885
f3 = −18.997
f4 = 39.529

As described above, in this example, it is found that the above-described conditional expressions (1) to (14) are all satisfied.

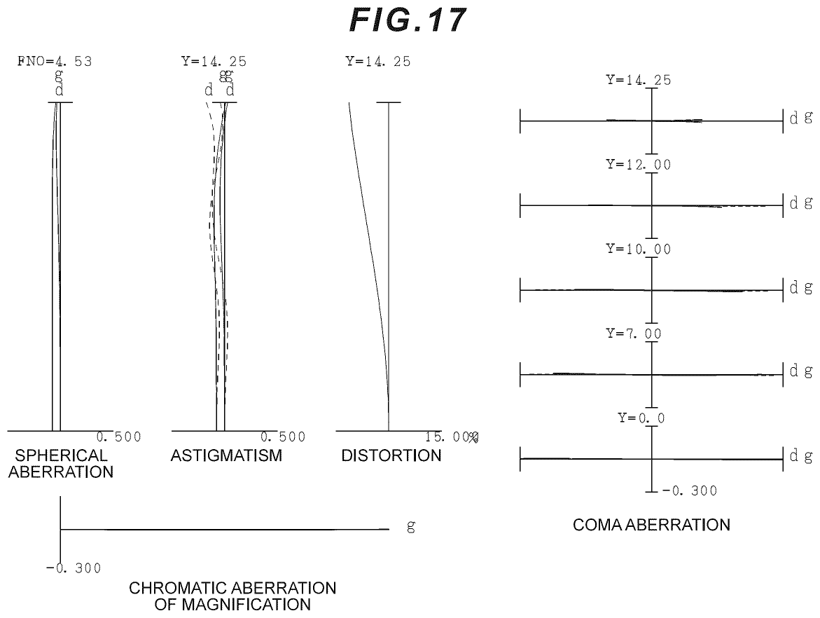

FIG. 17 and FIG. 18 are graphs illustrating various aberrations of the zoom optical system according to the sixth example upon focusing on infinity in the wide angle end state (f=12.36 mm) and in the telephoto end state (f=27.16 mm), respectively. It is found from the aberration graphs that, in the sixth example, in each of the focal length states from the wide angle end state to the telephoto end state, various aberrations are sufficiently corrected, and excellent optical performance is achieved. As a result, an optical device such as a camera can secure excellent optical performance by being mounted with the zoom optical system ZL(6) according to the sixth example.

Next, a table of [Conditional Expression Corresponding Value] is illustrated below. The table collectively shows values corresponding to the conditional expressions (1) to (14) for all the examples (first to sixth examples).

$$0.7 < ( - f 1 ) / f 2 < 1.3 \qquad Conditional expression ( 1 )$$

$$0.55 < f 2 / ( - f 3 ) < 1.2 \qquad Conditional expression ( 2 )$$

$$0.2 < ( - f 1 ) / f 4 < 0.5 \qquad Conditional expression ( 3 )$$

$$0.2 < ( - f 3 ) / f 4 < 0.9 \qquad Conditional expression ( 4 )$$

$$0.5 < f 1 / f 3 < 1.1 \qquad Conditional expression ( 5 )$$

$$0.2 < f 2 / f 4 < 0.7 \qquad Conditional expression ( 6 )$$

$$0.12 < fw / TLw < 0.19 \qquad Conditional expression ( 7 )$$

$$0.2 < ft / TLt < 0.5 \qquad Conditional expression ( 8 )$$

$$0.7 < Mv 2 / f 2 < 1.3 \qquad Conditional expression ( 9 )$$

$$0.36 < Mv 3 / ( - f 3 ) < 0.8 \qquad Conditional expression ( 10 )$$

$$1.2 < fvr / f 2 < 2.2 \qquad Conditional expression ( 11 )$$

$$1. < Mv 2 / Mv 3 < 1.8 \qquad Conditional expression ( 12 )$$

$$0.15 < Mv 2 / TL < 0.25 \qquad Conditional expression ( 13 )$$

$$0.08 < Mv 3 / TL < 0.2 \qquad Conditional expression ( 14 )$$

### [Conditional Expression Corresponding Value] (First to Sixth Example)

| Conditional | First | Second | Third |
|---|---|---|---|
| Expression | example | example | example |
| (1) | 0.921 | 0.911 | 1.014 |
| (2) | 0.854 | 0.969 | 0.695 |
| (3) | 0.353 | 0.319 | 0.389 |
| (4) | 0.449 | 0.361 | 0.552 |
| (5) | 0.786 | 0.883 | 0.705 |
| (6) | 0.383 | 0.350 | 0.384 |
| (7) | 0.160 | 0.171 | 0.160 |
| (8) | 0.352 | 0.376 | 0.351 |
| (9) | 0.825 | 0.865 | 0.860 |
| (10) | 0.457 | 0.514 | 0.384 |
| (11) | 1.907 | 1.474 | 1.640 |
| (12) | 1.542 | 1.630 | 1.557 |
| (13) | 0.180 | 0.182 | 0.179 |
| (14) | 0.117 | 0.111 | 0.115 |
| Conditional | Fourth | Fifth | Sixth |
| Expression | example | example | example |
| (1) | 0.952 | 0.900 | 1.198 |
| (2) | 0.841 | 0.673 | 0.784 |
| (3) | 0.412 | 0.392 | 0.451 |
| (4) | 0.515 | 0.647 | 0.481 |
| (5) | 0.800 | 0.606 | 0.939 |
| (6) | 0.433 | 0.435 | 0.377 |
| (7) | 0.161 | 0.135 | 0.178 |
| (8) | 0.353 | 0.355 | 0.391 |
| (9) | 0.838 | 1.099 | 0.941 |
| (10) | 0.458 | 0.543 | 0.573 |
| (11) | 1.779 | 1.480 | 1.621 |
| (12) | 1.540 | 1.361 | 1.287 |
| (13) | 0.185 | 0.247 | 0.202 |
| (14) | 0.120 | 0.182 | 0.157 |

As described above, according to each of the examples, it is possible to realize the zoom optical system and the optical device that have excellent optical performance while achieving size reduction.

In the above-descried embodiment, contents described below can be appropriately adopted as long as the optical performance is not impaired.

In each of the above-described examples, the zoom optical system includes a four-group configuration; however, the zoom optical system may include another group configuration such as a five-group configuration. Further, a configuration in which a lens or a lens group is added on the most object side, or a configuration in which a lens or a lens group is added on the most image side may be adopted. The lens group indicates a portion including at least one lens that is separated at an air distance varied upon zooming.

The focusing lens group that performs focusing from the infinity object to the short-distance object may be configured by moving a single or a plurality of lens groups or a partial lens group in the optical axis direction. The focusing lens group can be applied to autofocusing, and is suitable for autofocusing motor driving (using ultrasonic motor, etc.).

In the zoom optical system according to each embodiment, the vibration-proof lens group that corrects image blur caused by hand shake is not limited to some of the lenses in the second lens group, and may be configured by moving a lens group or a partial lens group so as to have components in the direction perpendicular to the optical axis or rotationally moving (swinging) a lens group or a partial lens group in an in-plane direction including the optical axis.

The lens surface may be formed of a spherical surface or a flat surface, or may be formed of an aspherical surface. In a case where the lens surface is a spherical surface or a flat surface, lens machining and assembly adjustment are easily performable, and deterioration of optical performance caused by an error in machining and assembly adjustment can be prevented, which is preferable. Further, even in a case where the image surface is displaced, deterioration of drawing performance is little, which is preferable.

In a case where the lens surface is an aspherical the aspherical surface may be any of an aspherical surface formed by grinding, a glass mold aspherical surface obtained by forming glass in an aspherical surface shape by a mold, and a composite aspherical surface obtained by forming a resin in an aspherical surface shape on a surface of glass. Further, the lens surface may be a diffraction surface, and the lens may be a gradient index lens (GRIN lens) or a plastic lens.

The aperture stop is preferably disposed in the second lens group; however, a member as the aperture stop may not be provided, and a frame of the lens may serve as the aperture stop.

Each lens surface may be provided with an antireflection film having high transmittance in a wide wavelength range in order to reduce flare and ghost and to achieve high contrast optical performance.

The zoom optical system according to the present embodiment is used in a camera; however, the usage is not limited thereto, and the zoom optical system according to the present embodiment may be used in an optical device such as a camera including a moving image imaging function.

### EXPLANATION OF NUMERALS AND CHARACTERS

ZL Zoom optical system
G1 First lens group
G2 Second lens group
G3 Third lens group
G4 Fourth lens group
S Aperture stop
I Image surface

1. A zoom optical system comprising, in order from an object side along an optical axis:
a first lens group having a negative refractive power;
a second lens group having a positive refractive power;
a third lens group having a negative refractive power; and
a fourth lens group having a positive refractive power, wherein
upon zooming, the first lens group is fixed relative to an image surface, and a distance between adjacent lens groups is varied, and
the following conditional expressions are satisfied:
$$0.7 < ( - f 1 ) / f 2 < 1 \text{.30}$$
$$0.55 < f 2 / ( - f 3 ) < 1.20$$
where f1: a focal length of the first lens group,
f2: a focal length of the second lens group, and
f3: a focal length of the third lens group.

2. The zoom optical system according to claim 1, wherein the following conditional expression is satisfied:
$$0.2 < ( - f 1 ) / f 4 < 0.50 ,$$
where f4: a focal length of the fourth lens group.

3. The zoom optical system according to claim 1, wherein the following conditional expression is satisfied:
$$0.2 < ( - f 3 ) / f 4 < 0.9$$
where f4: a focal length of the fourth lens group.

4. The zoom optical system according to claim 1, wherein the following conditional expression is satisfied:
$$0.5 < f 1 / f 3 < 1.1 .$$

5. The zoom optical system according to claim 1, wherein the following conditional expression is satisfied:
$$0.2 < f 2 / f 4 < 0.7$$
where f4: a focal length of the fourth lens group.

6. The zoom optical system according to claim 1, wherein the following conditional expression is satisfied:
$$0.12 0 < fw / TLw < 0.19$$
where fw: a focal length of the zoom optical system in a wide angle end state, and
TLw: an entire length of the zoom optical system in the wide angle end state.

7. The zoom optical system according to claim 1, wherein the following conditional expression is satisfied:
$$0.2 < ft / TLt < 0.5$$
where ft: a focal length of the zoom optical system in a telephoto end state, and
TLt: an entire length of the zoom optical system in the telephoto end state.

8. The zoom optical system according to claim 1, wherein the following conditional expression is satisfied:
$$0.7 < Mv 2 / f 2 < 1.3$$
where Mv2: a moving amount of the second lens group upon zooming from a wide angle end state to a telephoto end state.

9. The zoom optical system according to claim 1, wherein the following conditional expression is satisfied:
$$0.36 < Mv 3 / ( - f 3 ) < 0.80$$
where Mv3: a moving amount of the third lens group upon zooming from a wide angle end state to a telephoto end state.

10. The zoom optical system according to claim 1, further comprising an aperture stop disposed in the second lens group, wherein
the second lens group includes a vibration-proof lens group disposed on an image surface side of the aperture stop.

11. The zoom optical system according to claim 10, wherein the following conditional expression is satisfied:
$$1.2 < fvr / f 2 < 2.20$$
where fvr: a focal length of the vibration-proof lens group.

12. The zoom optical system according to claim 1, wherein the following conditional expression is satisfied:
$$1. < Mv 2 / Mv 3 < 1.80$$
where Mv2: a moving amount of the second lens group upon zooming from a wide angle end state to a telephoto end state, and
Mv3: a moving amount of the third lens group upon zooming from the wide angle end state to the telephoto end state.

13. The zoom optical system according to claim 1, wherein focusing from an infinity object to a short-distance object is performed by moving the third lens group on an optical axis.

14. The zoom optical system according to claim 1, wherein, upon zooming from a wide angle end state to a telephoto end state, the second lens group and the third lens group are moved toward the object, a distance between the first lens group and the second lens group is reduced, and a distance between the third lens group and the fourth lens group is increased.

15. The zoom optical system according to claim 1, wherein, upon zooming, the fourth lens group is fixed relative to the image surface.

16. The zoom optical system according to claim 1, wherein the following conditional expression is satisfied:
$$0. 15 < Mv 2 / TL < 0.25$$
where Mv2: a moving amount of the second lens group upon zooming from a wide angle end state to a telephoto end state, and
TL: an entire length of the zoom optical system.

17. The zoom optical system according to claim 1, wherein the following conditional expression is satisfied:
$$0.08 < Mv 3 / TL < 0.20$$
where Mv3: a moving amount of the third lens group upon zooming from a wide angle end state to a telephoto end state, and
TL: an entire length of the zoom optical system.

18. An optical device comprising the zoom optical system according to claim 1.

19. A method for manufacturing a zoom optical system, the zoom optical system including, in order from an object side along an optical axis, a first lens group having a negative refractive power, a second lens group having a positive refractive power, a third lens group having a negative refractive power, and a fourth lens group having a positive refractive power, the method comprising arranging lenses in a lens barrel to cause, upon zooming, the first lens group to be fixed relative to an image surface and a distance between adjacent lens groups to be varied, and to satisfy the following conditional expressions:
$$0.7 < ( - f 1 ) / f 2 < 1 \text{.30}$$
$$0.55 < f 2 / ( - f 3 ) < 1.20$$
where f1: a focal length of the first lens group,
f2: a focal length of the second lens group, and
f3: a focal length of the third lens group.
